(19) United States
(12) Patent Application Publication
(10) Pub. No.: US 2026/0301487 A1
(43) Pub. Date: Oct. 1, 2026

(54) SMART DOOR LOCK

(71) Applicant: ASSA ABLOY Level LLC, Redwood City, CA (US)

(72) Inventors: Aram Antonyan, Redwood City, CA (US); Jordan R. Fountain, Truckee, CA (US); Kenneth D. Goto, Montecito, CA (US); Bjorn Hanks, Redwood City, CA (US); Suhaib Ishaque, Redwood City, CA (US); Timothy Lee, Redwood City, CA (US); Devin Spratt, Redwood City, CA (US)

(73) Assignee: ASSA ABLOY Level LLC, Redwood City, CA (US)

(21) Appl. No.: 19/564,297

(22) Filed: Mar. 12, 2026

Related U.S. Application Data
(60) Provisional application No. 63/779,762, filed on Mar. 28, 2025.

(51) Int. Cl. G07C 9/00

(52) U.S. Cl. CPC G07C 9/00174; G07C 2009/00634; G07C 2209/64

(57) ABSTRACT

There is provided an electronic door lock system and techniques for operating the same which reduce the energy consumption of the electronic door lock system. The electronic door lock system may include an electronic lock configured to be coupled to a door, the electronic lock comprising at least one magnetometer; a strike plate configured to be coupled to a frame of the door, the strike plate having a plurality of magnets disposed therein; and at least one controller configured to determine whether the door is open or closed based on one or more measurements of magnetic field strength measured by the at least one magnetometer, wherein the plurality of magnets generate a magnetic field that contributes to the magnetic field strength measured by the at least one magnetometer.

### CROSS-REFERENCE TO RELATED APPLICATIONS

This application claims the benefit under 35 U.S.C. § 119(e) to U.S. Provisional Application Ser. No. 63/779,762 titled “SMART DOOR LOCK” and filed on Mar. 28, 2025, the entire contents of which is incorporated by reference herein in its entirety.

### FIELD

Aspects of the technology described herein relate to an electronic door lock system having an electronic lock, and in particular, an electronic door lock system having features which reduce energy consumption of the electronic door lock system.

### BACKGROUND

Locks can be configured to fasten doors to inhibit unauthorized entry into buildings. Conventional door locks include a deadbolt which can be moved between a locked and unlocked position by extending and retracting the deadbolt. The deadbolt may be retracted to unlock the door lock from an interior face of the door by manually turning a thumb turn in a first direction, or from an exterior face of the door by inserting a key into a keyhole of the door lock and rotating the key in the first direction. Similarly, the deadbolt may be extended to lock the door from an interior face of the door by manually turning a thumb turn in a direction opposite the first direction, or from an exterior face of the door by inserting a key into a keyhole of the door lock and rotating the key in the direction opposite the first direction.

In some cases, door locks may be controlled electronically. For example, door locks may include electronically-powered mechanisms that facilitate automatic movement of a deadbolt between an unlocked position and a locked position.

### SUMMARY

According to some aspects, there is provided an electronic door lock system comprising: an electronic lock configured to be coupled to a door, the electronic lock comprising at least one magnetometer; a strike plate configured to be coupled to a frame of the door, the strike plate having a plurality of magnets disposed therein; and at least one controller configured to determine whether the door is open or closed based on one or more measurements of magnetic field strength measured by the at least one magnetometer, wherein the plurality of magnets generate a magnetic field that contributes to the magnetic field strength measured by the at least one magnetometer.

According to some aspects, there is provided a method of monitoring a position of a door coupled to an electronic door lock system, the method comprising: obtaining one or more measurements of magnetic field strength from at least one magnetometer of an electronic lock of the electronic door lock system coupled to the door, the electronic door lock system further comprising a strike plate coupled to a frame of the door and having a plurality of magnets disposed therein, wherein the plurality of magnets generate a magnetic field that contributes to the magnetic field strength measured by the at least one magnetometer; and determining whether the door is open or closed based on the one or more measurements of magnetic field strength of the at least one magnetometer.

According to some aspects, there is provided at least one non-transitory computer-readable storage medium having instructions encoded thereon that, when executed by at least one processor, cause the at least one processor to perform a method of monitoring a position of a door coupled to an electronic door lock system, the method comprising: obtaining one or more measurements of magnetic field strength from at least one magnetometer of an electronic lock of the electronic door lock system coupled to the door, the electronic door lock system further comprising a strike plate coupled to a frame of the door and having a plurality of magnets disposed therein, wherein the plurality of magnets generate a magnetic field that contributes to the magnetic field strength measured by the at least one magnetometer; and determining whether the door is open or closed based on the one or more measurements of magnetic field strength of the at least one magnetometer.

### BRIEF DESCRIPTION OF THE DRAWINGS

Various aspects and embodiments will be described with reference to the following figures. It should be appreciated that the figures are not necessarily drawn to scale. For purposes of clarity, not every component may be labeled in every drawing. In the drawings:

FIG. 1A illustrates an example schematic diagram of an electronic door lock system, according to some embodiments of the technology described herein.

FIG. 1B illustrates an example diagram of an example electronic lock that may be used in the electronic door lock system of FIG. 1A, according to some embodiments of the technology described herein.

FIG. 2A illustrates a perspective view of an example electronic door lock system, according to some embodiments of the technology described herein.

FIG. 2B illustrates another perspective view of the example electronic door lock system of FIG. 2A, according to some embodiments of the technology described herein.

FIG. 2C illustrates a top view of the example electronic door lock system of FIG. 2A, according to some embodiments of the technology described herein.

FIG. 2D illustrates a front interior view of the example electronic door lock system of FIG. 2A, according to some embodiments of the technology described herein.

FIG. 2E illustrates a rear exterior view of the example electronic door lock system of FIG. 2A, according to some embodiments of the technology described herein.

FIG. 2F illustrates a side view of the example electronic door lock system of FIG. 2A, according to some embodiments of the technology described herein.

FIG. 2G illustrates an inner face of the exterior portion of the electronic lock of FIG. 2A, according to some embodiments of the technology described herein.

FIG. 2H illustrates a lock body of the electronic lock of FIG. 2A, according to some embodiments of the technology described herein.

FIG. 3 illustrates a rear exterior view of an electronic lock of the example electronic door lock system of FIG. 2A having a front escutcheon removed, according to some embodiments of the technology described herein.

FIG. 4 illustrates a perspective view of the example electronic door lock system of FIG. 2A where a portion of a housing of the electronic lock is transparent, according to some embodiments of the technology described herein.

FIG. 5 illustrates a cross-sectional view taken along line 5-5 of FIG. 2F, according to some embodiments of the technology described herein.

FIG. 6A illustrates a front view of an example strike plate of the example electronic door lock system of FIG. 2A, according to some embodiments of the technology described herein.

FIG. 6B illustrates a rear view of an example strike plate of FIG. 6A, according to some embodiments of the technology described herein.

FIG. 6C illustrates an exploded rear perspective view of the example strike plate of FIG. 6A, according to some embodiments of the technology described herein.

FIG. 6D illustrates another example strike plate of an electronic door lock system, according to some embodiments of the technology described herein.

FIG. 7 illustrates an example method for monitoring a position of a door coupled to an electronic door lock system, according to some embodiments of the technology described herein.

FIG. 8 illustrates an example method for calibration a magnetometer in an electronic lock of an electronic door lock system, according to some embodiments of the technology described herein.

FIG. 9 illustrates a side view of the electronic lock of FIG. 3 illustrating a deadbolt of the electronic lock, according to some embodiments of the technology described herein.

FIG. 10 illustrates an example method for controlling an electronic door lock system, according to some embodiments of the technology described herein.

FIG. 11 illustrates a rear exterior view of the electronic lock of FIG. 3 illustrating aspects of a front escutcheon of the electronic lock, according to some embodiments of the technology described herein.

FIG. 12 illustrates another example method for controlling an electronic door lock system, according to some embodiments of the technology described herein.

FIG. 13 illustrates a rear exterior view of the electronic lock of FIG. 3, having a portion of a front escutcheon removed, according to some embodiments of the technology described herein.

FIG. 14 illustrates another example method for controlling an electronic door lock system, according to some embodiments of the technology described herein.

FIG. 15 illustrates a block diagram of an example computer system on which embodiments of the technology described herein may be implemented.

### DETAILED DESCRIPTION

### I. Introduction

Aspects of the technology described herein provide for an electronic door lock system including an electronic lock, or “smart door lock.” That is, the electronic door lock system includes an electronic lock configured to be coupled to a door, along with other components, including a strike plate configured to be coupled to a frame of the door, which enables a user to electronically lock and unlock the door.

According to some aspects, the electronic door lock system is configured having features that reduce power consumption of the system. For example, in some embodiments, the electronic door lock system performs one or more functions, such as polling for a wireless communication connection (e.g., Bluetooth, near-field communication (NFC)) and/or operation of one or more second sensors, which are operated selectively based on a status of the electronic door lock system. In particular, the electronic door lock system may be configured to initiate or increase the frequency of such functions based on an indication that the door status has changed (e.g., between lock and unlock, between open and closed) and/or an indication that a person is in proximity of the electronic door lock system. In this way, the energy consumption of the one or more functions may be reduced.

The indication that the door status has changed may be determined based on input from one or more sensors of the electronic door lock system. According to some aspects, the electronic door lock system includes one or more magnetometers that measure magnetic field strength. The electronic door lock system may further include a plurality of magnets disposed in a strike plate of the system such that measurements of magnetic field strength may be used to determine whether a status of the electronic lock (and by extension, the door) has changed. Techniques are further provided herein for calibrating one or more magnetometers of an electronic door lock system.

According to some aspects, the electronic door lock system includes one or more accelerometers that measure acceleration. The measurements of acceleration may be used to determine whether a status of the electronic lock and door has changed.

The indication that a person is in proximity of the electronic door lock system may be determined based on input from one or more sensors of the electronic door lock system. According to some aspects, the electronic door lock system may include one or more sensors for measuring a heat differential. The measured heat differential may be used (e.g., compared to a threshold) to determine whether a person is in proximity of the electronic door lock system.

According to some aspects, the electronic door lock system is configured having features which facilitate ease of user operation of the electronic lock. For example, the electronic lock may include one or more sensors which detect a touch input from a user and control the electronic lock based on the detection of the touch input.

The aspects and embodiments described above, as well as additional aspects and embodiments, are described further below. These aspects and/or embodiments may be used individually, all together, or in any combination, as the application is not limited in this respect.

### II. Example Electronic Door Lock System

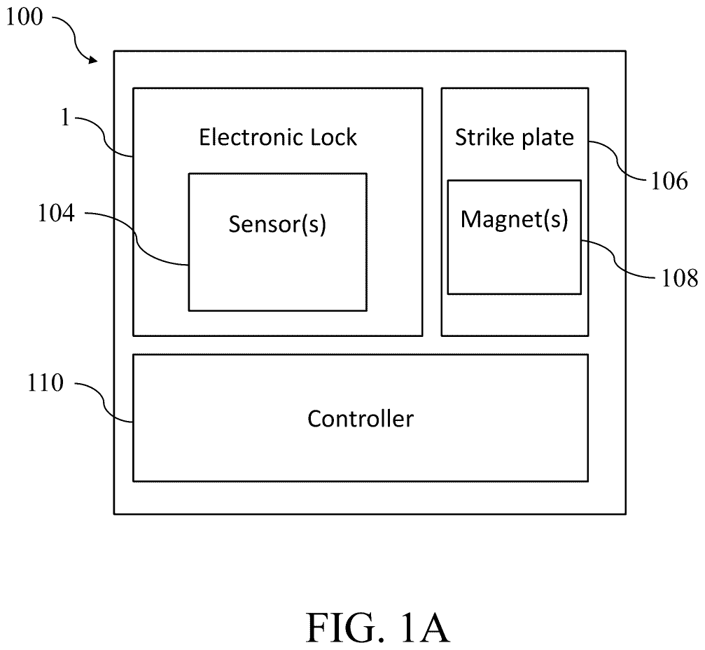

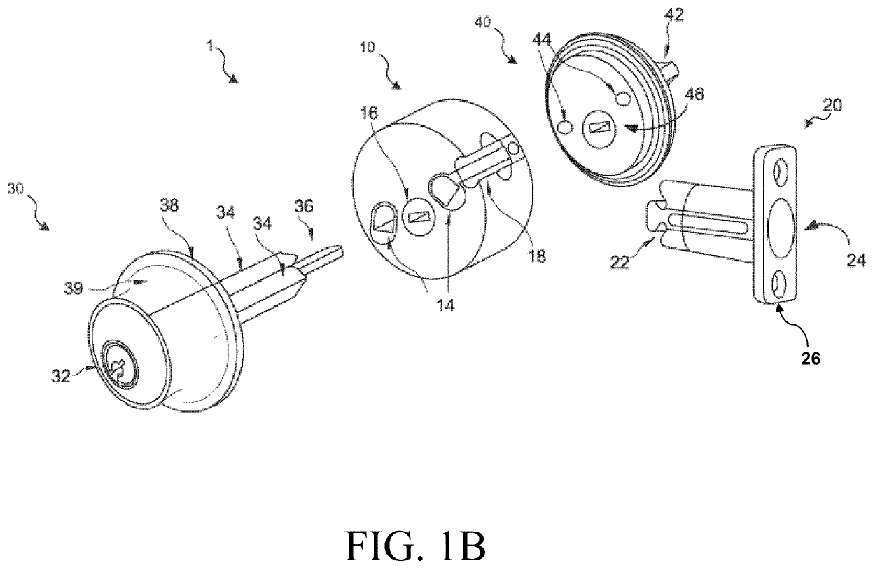

As described herein, aspects of the technology provide for an electronic door lock system. FIG. 1A illustrates an example schematic diagram of an electronic door lock system 100, according to some embodiments of the technology described herein.

As shown in FIG. 1A, the electronic door lock system 100 includes an electronic lock 1, a strike plate 106, and a controller 110. The electronic lock 1 is configured to be coupled to a door, to allow and restrict access through the door. The electronic lock 1 may be configured to perform at least some operations electronically, without requiring manual interaction from a user. For example, the electronic lock 1 may be configured to lock electronically in response to a command from a user. The electronic lock 1 may be configured to electronically communicate (e.g., wirelessly) information about the electronic lock 1 to and/or from an external device. Such information may include door status (e.g., lock or unlock status, open or close status, whether the lock is jammed), operations of the electronic lock 1 (e.g., an indication that the door status has changed) and/or whether a person has been detected at the door. The information may further include information received from an external device, such as a command to lock or unlock the electronic lock and/or credential information that may be used to verify the external device as a trusted device able to control the electronic lock 1.

In the illustrated embodiment of FIG. 1A, the electronic lock 1 includes one or more sensors 104. For example, the one or more sensors 104 may be disposed in a housing of the electronic lock 1. The one or more sensors 104 are configured to measure one or more characteristics related to the electronic lock. For example, the one or more sensors 104 may include an accelerometer configured to measure acceleration of the electronic lock 1, as is further described herein. In another example, the one or more sensors 104 may include a magnetometer, configured to measure a magnetic field strength. In another example, the one or more sensors 104 may include a sensor configured to measure a temperature differential. In another example, the one or more sensors 104 may include a sensor configured to measure temperature (e.g., a thermistor). In yet another example, the one or more sensors 104 may include a sensor configured to detect a touch from a user on the electronic lock 1. The information obtained from the one or more sensors 104 may be used to determine door status, including whether door status has changed, and/or whether a person is in the proximity of the electronic lock, and the electronic lock 1 may be controlled based on the determination, as is described herein.

The controller 110 may be configured to control operation of the electronic lock 1. For example, the controller 110 may be electrically coupled to the electronic lock 1 and control the electronic lock to lock and/or unlock. The controller 110 may be configured to control operation of the one or more sensors 104, including controlling when and/or how frequently the one or more sensors 104 operate. The controller 110 may be configured to control aspects of communications of the electronic lock 1. For example, the electronic lock 1 may include communication circuitry, such as one or more antennas (e.g., one or more NFC antennas), and the controller 110 may be configured to control whether and/or how frequently the electronic lock 1 is polling for wireless communication. Although the controller 110 is shown as being a separate component in the illustrated embodiment of FIG. 1A, it should be appreciated that the controller 110 may form part of the electronic lock 1. For example, the controller 110 may be disposed in a housing of the electronic lock 1, in some embodiments.

The strike plate 106 is configured to be coupled to a frame of the door to which the electronic lock 1 is coupled. When the door is closed and locked, a deadbolt of the electronic lock 1 extends through an opening in the strike plate 106. As shown in FIG. 1A, the strike plate 106 includes one or more magnets 108. Aspects of the one or more magnets 108 are further described herein.

FIG. 1B illustrates an example diagram of an example electronic lock 1 that may be used in the electronic door lock system 100 of FIG. 1A, according to some embodiments of the technology described herein. The electronic lock 1 can include a lock body 10, deadbolt housing 20, outer/exterior housing 30, and inner/interior housing 40. The exterior housing 40 may include a key cylinder for locking or unlocking the lock via a mechanical key. The interior housing may include a thumb turn to allow a user on the interior space to lock or unlock the lock from the interior.

The lock body 10 can include components to mechanically move a deadbolt 24 between a locked position and an unlocked position. For example, the lock body 10 can include an actuator, gear drive, or any other components that can assist in mechanically moving a deadbolt between a locked position and an unlocked position. In one embodiment, the lock body 10 includes a motor that can be activated (e.g., turned on) to retract or extend the deadbolt 24 without having the person operating the lock (e.g., the homeowner) manually use a key (not shown) or the thumb turn.

The lock body 10 can also include electronic components disposed within the lock body 10, such as a circuit board, a processor, or an antenna. The electronic lock 1 can be a “smart” lock having a variety of functionality including computing devices having wireless communications capabilities that allow it to communicate with other computing devices. For example, a homeowner can have a user device, such as a smartphone, which can wirelessly communicate with electronic components in the lock body 10 via one of the Institute of Electrical and Electronics Engineers (IEEE) 802.1 standards, Bluetooth®, Zigbee, Z-Wave, Matter over Thread, near-field communication (NFC), and/or other wireless communication techniques. In some implementations, electronic components in the lock body 10 can access a network such as the Internet via the user device. In other implementations, a network may be accessed without the user device as an intermediary. Thus, electronic lock I and the homeowner's smartphone can exchange data amongst themselves. For example, the electronic lock 1 can provide data regarding the state of the electronic lock 1 to the smartphone so that the homeowner knows whether the deadbolt 24 is in a locked position or an unlocked position. The lock body 10 can also receive data from a smartphone via wireless communications, for example providing an instruction to transition the deadbolt 24 from a locked position to an unlocked position. The electronic components in lock body 10 can be powered by a power supply disposed within the deadbolt 24 in the deadbolt housing 20.

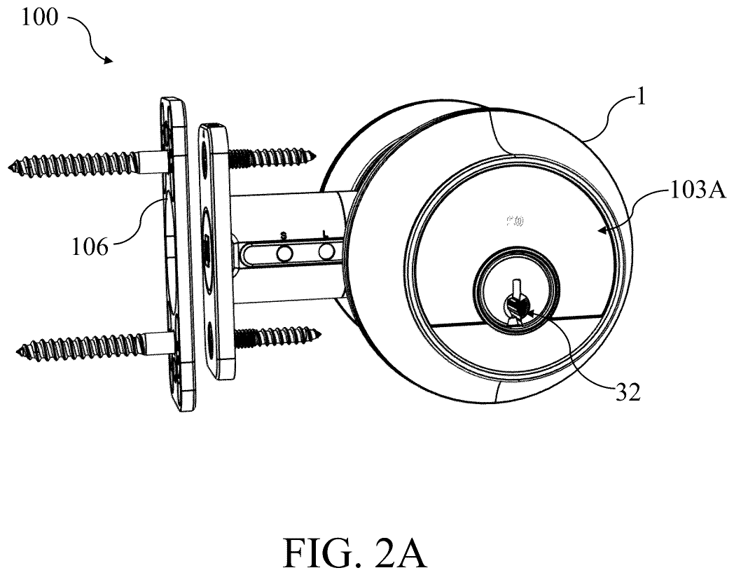

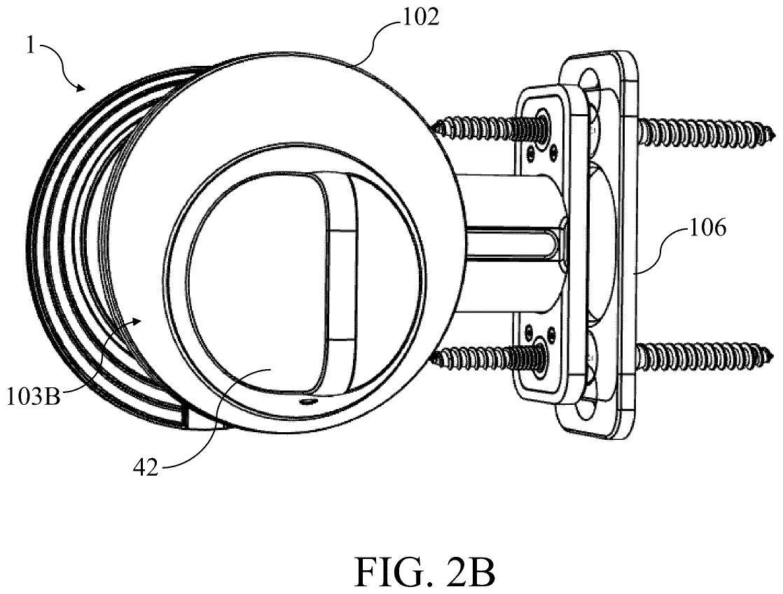

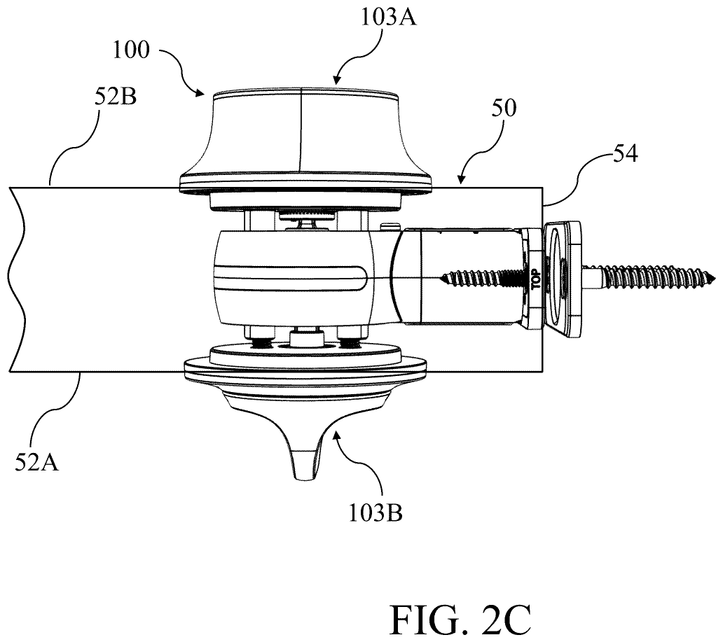

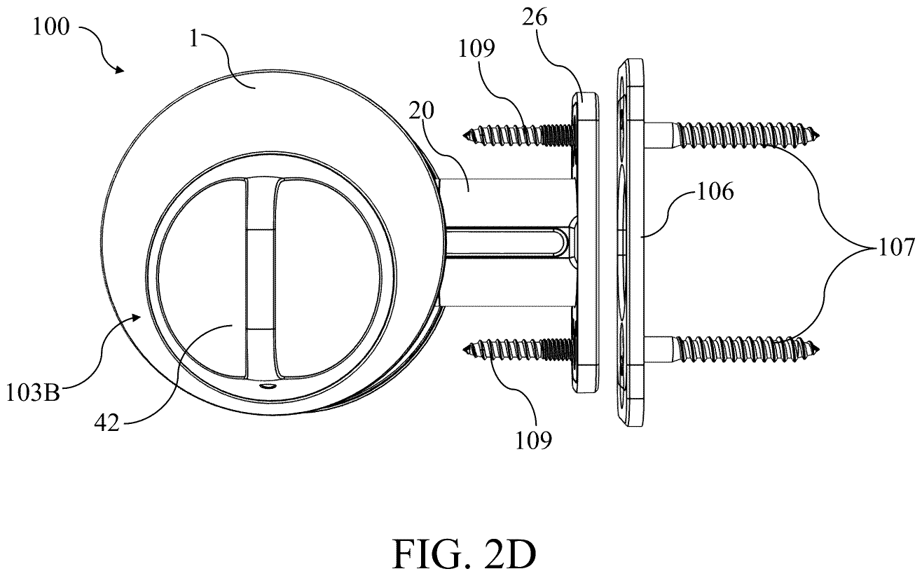

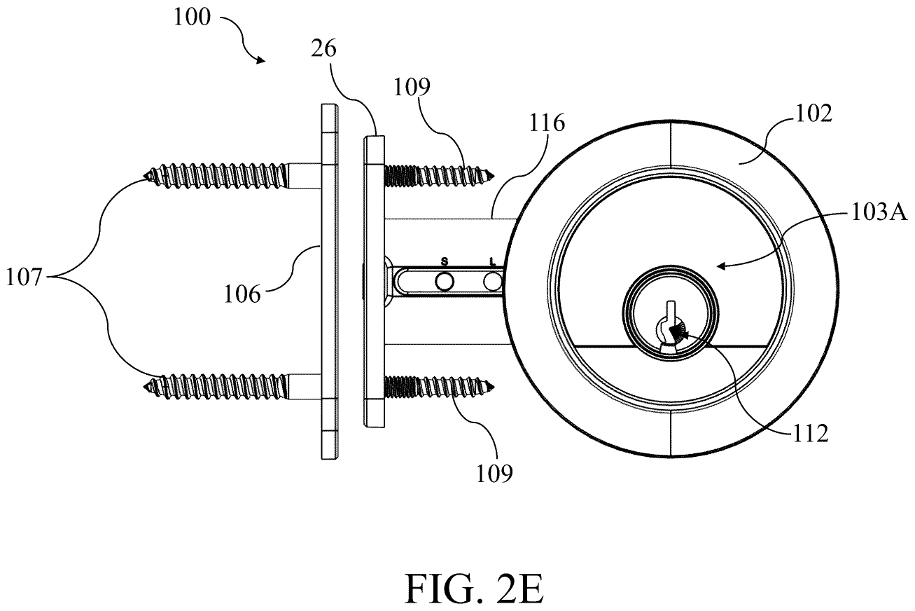

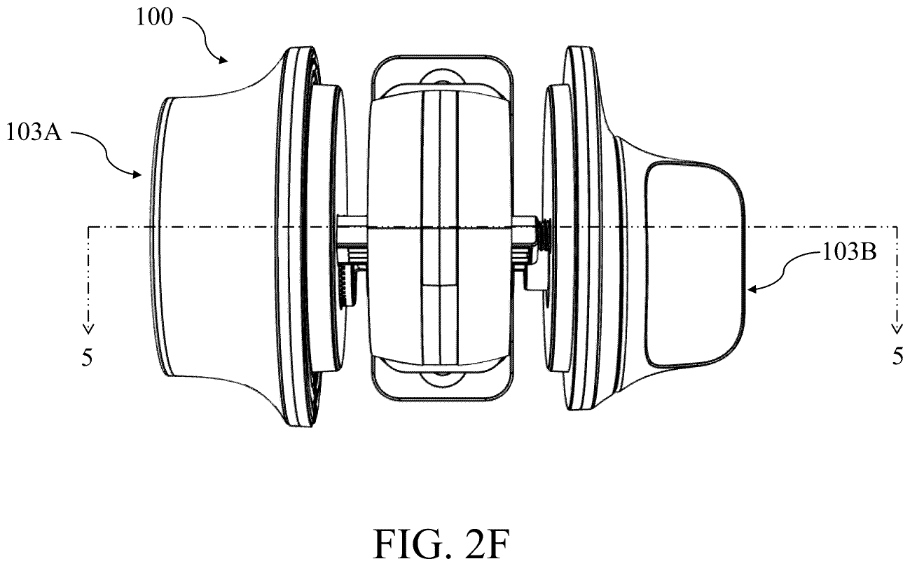

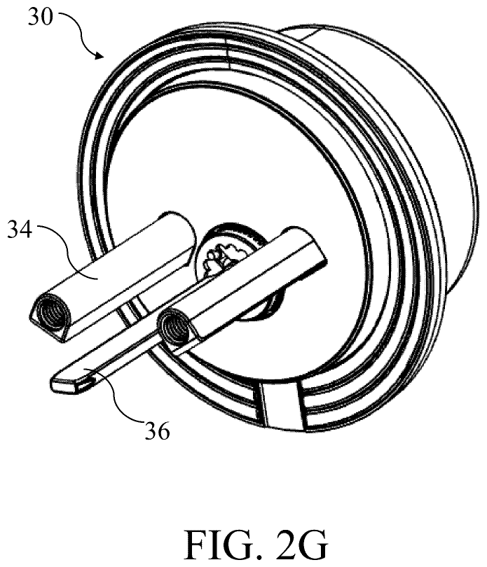

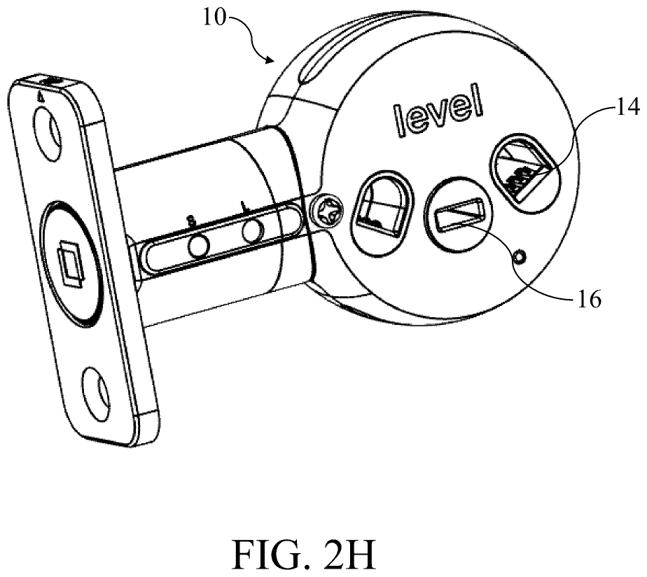

The main housing can have a substantially circular footprint and be configured to be disposed within a standard bore hole disposed within a door. For example, the lock body 10 can be configured to be disposed within an American National Standards Institute® (ANSI) deadbolt bore hole, which has a diameter of 2⅛ inches. In another example, a depth of the lock body 10 can be configured to fit within an ANSI standard door thickness, which is 1¾ inch (as shown in FIG. 2C). The lock body 10 can include openings 14 and 16. These openings can include a conductive portion and/or be configured to facilitate mechanical movement of a deadbolt. For example, as shown in FIG. 1B, openings 14 are conductive openings. As shown in FIG. 1B, opening 16 is configured to rotate to facilitate extension or retraction of a deadbolt 24. In some embodiments, the deadbolt may weigh relatively little, such that minimal battery power is required to extend or retract the deadbolt, thereby extending the battery life of the electronic lock.

The lock body 10 can be configured to engage with a deadbolt housing 20. The lock body 10 and deadbolt housing 20 can be engaged at a deadbolt carriage 18 of the lock body 10. For example, the deadbolt carriage 18 can include a female connector groove that connects to a male connector 22 of the deadbolt housing 20, as shown in FIG. 1B. Connections between the lock body 10 and the deadbolt housing 20 may take any number of forms, including mechanical or electromagnetic connections. The lock body 10 can engage with the deadbolt housing 20 to cause a deadbolt 24 within the deadbolt housing 20 to move between a locked position and an unlocked position. For example, the locked position can include extending the deadbolt 24 into a wall, and the unlocked position can include retracting the deadbolt 24 into the deadbolt housing 20. As shown in FIG. 1B, the deadbolt 24 is retracted in the deadbolt housing 20 in an unlocked position. The deadbolt housing 20 can further include a plate 26. The plate 26 can be attached to a door, for example using screws. The plate 26 can be multiple sizes or shapes to accommodate different doors. For example, the plate 26 can have different height, width, or depth to match a cutout in a door. In another example, the plate 26 can be rectangular and have either rounded or sharp corners.

The deadbolt 24 can be configured to receive a power supply. The power supply can include, for example, an electrochemical cell (e.g., a flow battery, ultrabattery, and/or rechargeable battery), a capacitor (e.g., a supercapacitor), an energy storage coil (e.g., a superconducting magnetic energy storage device), a compressed air energy storage device, a flywheel, a hydraulic accumulator, a chemical energy storage device (e.g., hydrogen storage), or any combination of energy storage devices. For example, the power supply can be a small battery, such as a lithium CR2 battery. The deadbolt housing 20 can be configured to receive power from the power supply. The lock body 10 can be electrically connected to the deadbolt housing 20. For example, the deadbolt carriage 18 of the lock body 10 and the male connector 22 of the deadbolt housing 20 can both include pins. Engaging the respective pins can then allow current to flow to the lock body 10 from the power supply within the deadbolt housing 20.

The deadbolt housing 20 can be extendable to accommodate bolt caps on the deadbolt of varying size. In particular, the deadbolt housing 20 may extend to accommodate a bolt cap with a length matching a standard bore hole, such as an ANSI standard bore hole with 2⅛ inch diameter and 2¾ inch backset.

The outer/exterior housing 30 can be disposed exterior of a door and face outside of a secure environment. For example, the outer housing can be disposed outside of a house or apartment. The outer housing can include a key cylinder having a keyhole 32 configured to receive a key that can lock or unlock the deadbolt 24.

The outer/exterior housing 30 can include a set of prongs 34 and 36 to engage with the lock body 10. In the example shown in FIG. 1B, the center prong 36 can engage with the opening 16 of the lock body 10. Rotation of the keyhole 32 can be coupled with rotation of the center prong 36, which causes rotation of the opening 16 of the lock body 10 and thereby facilitating movement of the deadbolt 24 between a locked position and an unlocked position.

The prongs 34 and 36 can be conductive to allow for electrical transmission between the outer/exterior housing 30 and the lock body 10. For example, as shown in FIG. 1B, the prongs 34 are conductive prongs, while prong 36 is not conductive in this example.

The conductive prongs 34 can engage with the conductive openings 14 of the lock body 10, allowing for electrical transmission between the lock body 10 and outer/exterior housing 30. As noted above, the lock body 10 can be electrically connected to the deadbolt housing 20, which can include a power supply within the deadbolt 24. Thus, current can flow from the power supply within the deadbolt 24 to the outer/exterior housing 30, powering any electrical components included in the outer/exterior housing 30. For example, a portion of the outer/exterior housing 30 can include a capacitive touch sensor 39 configured to detect a touch by a user. In another example, the outer housing can include a near-field communication (NFC) sensor configured to receive a signal from a card or mobile device.

The outer/exterior housing 30 can include a leakage region 38 that facilitates signal transmission through the outer housing. The leakage region 38 can allow for increased wireless transmission from an exterior of the outer/exterior housing 30 to a wireless communication component in the lock body 10. For example, a lock body 10 disposed within a metal door can receive a weaker wireless signal compared to a lock body 10 disposed within a wood door. In that case, an outer/exterior housing 30 including a leakage region 38 disposed on an exterior of the metal door can have higher transmission of the wireless signal received by the lock body 10 relative to an outer/exterior housing 30 without a leakage region. In some embodiments, the leakage region 38 can be composed of any material that allows wireless transmission though the material. For example, a leakage region 38 designed to allow transmission of a Bluetooth signal can be composed of plastic, glass, or silicone. In other embodiments, the leakage region 38 can include components that amplify a wireless signal, such as an antenna or a signal booster. As shown in the example in FIG. 1B, the leakage region 38 is located on a perimeter of the outer/exterior housing 30. Also as shown in FIG. 1B, the leakage region 38 is positioned to contact an exterior of a door, which can provide for increased security and aesthetics.

The inner/interior housing 40 can be configured to protrude from the surface of the door and extend toward the secure environment, such as inside a house. The inner/interior housing 40 can engage with the lock body 10 and outer/exterior housing 30. As shown in the example in FIG. 1B, the inner/interior housing 40 can engage with the lock body 10 and outer/exterior housing 30 via the prongs 34 and 36. The inner/interior housing 40 can include openings 44, which can be secured to the prongs 34 of the outer housing, for example, by a set of screws.

The inner housing can be attached to a rotating member 42 that causes the deadbolt 24 to transition between a locked position and an unlocked position. For example, rotation of the rotating member 42 clockwise can initiate mechanical movement of the deadbolt 24 from the unlocked position to the locked position. As shown in the example in FIG. 1B, the rotating member 42 can include a thumb turn to assist a user in manual rotation of the rotating member 42. The rotating member 42 is not limited to a thumb turn, but can include any suitable hardware, such as a knob, lever, handle, button, etc. As shown in FIG. 1B, the center prong 36 of the outer housing can extend through opening 16 of the lock body 10 into a notch 46 of the inner housing. Rotation of the rotating member 42 can cause the notch 46 to rotate, causing the opening 16 of the lock body 10 to rotate via the center prong 36, thereby causing the deadbolt 24 to transition between a locked position and an unlocked position. As discussed in more detail below, the rotating member can include a magnet with opposing polarity to another magnet on the inner housing, which allows for smooth rotation and an enhanced tactile experience for a user.

The electronic lock 1 may form a seal with the door to prevent liquid from entering inside the electronic lock 1. In some embodiments, the seal may be formed of a layer of plastic (e.g., approximately 2 mm thick). In some embodiments, the seal may act as a radio frequency (RF) window that permits RF waves to escape from inside the electronic lock 1.

The electronic lock 1 may be designed to be durable. For example, the materials of the electronic lock 1 may be selected to increase the longevity of the electronic lock 1. In some embodiments, the electronic lock 1 may be rated to withstand low and high temperatures. For example, the electronic lock 1 may be rated for a range of −20 to 60 degrees Celsius, in some embodiments.

Further aspects of electronic locks that may be implemented in the electronic door lock system described herein include those described in U.S. Pat. No. 11,746,563 filed Dec. 7, 2020, granted Sep. 5, 2023, and entitled “SMART DOOR LOCK”, and U.S. Pat. No. 11,879,268 filed Dec. 12, 2018, granted Jan. 23, 2024, and entitled “DOOR LOCK BEZEL WITH TOUCH AND WIRELESS CAPABILITIES”, each of which are hereby incorporated by reference in their entireties.

FIGS. 2A-2F illustrate views of an example electronic door lock system 100. FIG. 2A illustrates a perspective view of an example electronic door lock system, according to some embodiments of the technology described herein. In particular, FIG. 2A illustrates the electronic lock 1 and a strike plate 106. As described herein, the electronic lock 1 may be coupled to a door. In the illustrates embodiment, the electronic door lock system 100 includes a pair of screws which may be used to fasten the electronic lock 1 to a door. The electronic door lock system 100 further includes a pair of screws which may be used to fasten the strike plate 106 to a frame of the door.

FIG. 2A illustrates an exterior face 103A of the electronic lock 1. When the electronic lock 1 is installed on a door, the exterior face 103A faces the exterior of the area (e.g., building or room) to which the door restricts access. For example, the electronic lock 1 may be installed on an entry door to a house, and the exterior face 103A would face the outside of the house. The exterior face 103A includes the keyhole 32 configured to receive a key that can lock or unlock the deadbolt.

FIG. 2B illustrates another perspective view of the example electronic door lock system 100 of FIG. 2A, according to some embodiments of the technology described herein. FIG. 2B illustrates an interior face 104B of the electronic lock. When the electronic lock 1 is installed on a door, the interior face 104B faces the interior of the area to which the door restricts access. For example, when the electronic lock 1 is installed on an entry door to a house, the interior face 103B would face the interior of the house. The interior face 103B includes a rotating member 42 which causes a deadbolt of the electronic lock 1 to transition between a locked position and an unlocked position so that a user may manually lock and unlock the door from the interior of the area to which the door restricts access.

FIG. 2C illustrates a top view of the example electronic door lock system 100 of FIG. 2A, according to some embodiments of the technology described herein. FIG. 2B illustrates that the exterior face 103A and the exterior face 103B of the electronic lock 1 are disposed on opposing sides of the electronic lock 1. In the illustrated example of FIG. 2C, a schematic representation is provided illustrating where the door 50 would be located. The door 50 includes an interior face 52A, an exterior face 52B, and an edge face 54. The interior face 52A faces an interior of the space which the door controls access to. The exterior face 52B faces an exterior of the space which the door 50 controls access to. When the electronic lock 1 is coupled to the door 50, the exterior face 103A of the electronic lock 1 faces a same direction as the exterior face 52B of the door 50, and the interior face 103B of the electronic lock 1 faces a same direction as the interior face 52A. The edge face 54 faces the strike plate 106 of the electronic door lock system 100.

FIG. 2D illustrates a front interior view of the example electronic door lock system 100 of FIG. 2A, according to some embodiments of the technology described herein. The front interior view shown in FIG. 2D illustrates the interior face 103B of the electronic lock 1. FIG. 2D illustrates the pair of screws 109 that fasten the electronic lock 1 to the door. FIG. 2D further illustrates the pair of screws 107 which fasten the strike plate 106 to the frame of the door. Although the illustrated embodiments illustrate a pair of screws as means for fastening the electronic lock to the door, and the strike plate to the frame of the door, respectively, it should be understood that the any suitable means for fastening the components of the electronic door lock system 100 in any suitable number may be used in the electronic door lock system 100. FIG. 2D further illustrates deadbolt housing 20 for the for the deadbolt of the electronic lock 1 and a plate 26 which facilitates coupling of the electronic lock 1 to the door via the pair of screws 109.

FIGS. 2E-2F illustrate additional views of the electronic door lock system 100. FIG. 2E illustrates a rear exterior view of the example electronic door lock system 100 of FIG. 2A, according to some embodiments of the technology described herein. FIG. 2F illustrates a side view of the example electronic door lock system 100 of FIG. 2A, according to some embodiments of the technology described herein.

As described herein, the electronic lock 1 may include a set of prongs 34 and 36 to facilitate an electrical connection between an outer/exterior housing 30 and a lock body 10 of the electronic lock 1. FIG. 2G illustrates an inner face of the exterior portion of the electronic lock of FIG. 2A, illustrating the set of prongs 34 and 36 of the electronic lock, according to some embodiments of the technology described herein.

The set of prongs 34 and 36 engage with openings 14 and 16 of the lock body 10. FIG. 2H illustrates a lock body of the electronic lock of FIG. 2A including the openings 14 and 16, according to some embodiments of the technology described herein.

As described herein, the electronic door lock system 100 is configured to allow and restrict access to an area via a door. The electronic lock 1 may be configured to lock in a number of ways. For example, the electronic lock 1 may be locked manually by engaging the rotating member of the electronic lock, manually via a key inserted into the keyhole on the exterior face of the electronic lock, via a touch input (e.g., as described herein), in response to a command (e.g., coupled with a valid credential which may, in some cases, be a temporary credential provided to a visitor) received via wireless communication (e.g., Bluetooth communication, NFC communication, Matter over Thread communication, Matter over WiFi communication, Z Wave communication, Zigbee communication) and/or via an interface (e.g., a keypad in communication with the electronic lock 1), and/or automatically (e.g., based on detecting a condition has been met such as an authorized user approaching, at a certain time of day).

The electronic lock 1 may be configured to unlock in a number of ways. For example, the electronic lock 1 may be unlocked manually by engaging the rotating member of the electronic lock, manually via a key inserted into the keyhole on the exterior face of the electronic lock, via a touch input (e.g., as described herein), in response to a command (e.g., coupled with a valid credential which may, in some cases, be a temporary credential provided to a visitor) received via wireless communication (e.g., Bluetooth communication, NFC communication, Matter over Thread communication, Matter over WiFi communication, Z Wave communication, Zigbee communication) and/or via an interface (e.g., a keypad in communication with the electronic lock) and/or automatically (e.g., based on detecting a condition has been met such as an authorized user approaching, at a certain time of day, based on a change in door status).

### III. Electronic Lock With Magnetometer

As described herein, the electronic door lock system may be configured having features that reduce power consumption of the system. For example, in some embodiments, the electronic door lock system performs one or more functions, such as polling for a wireless communication connection (e.g., Bluetooth, near-field communication (NFC)) and/or operation of one or more second sensors, which are operated selectively based on a status of the electronic door lock system. In particular, the electronic door lock system may be configured to initiate or increase the frequency of such functions based on an indication that the door status has changed (e.g., between lock and unlock, between open and closed) and/or an indication that a person is in proximity of the electronic door lock system. In this way, the energy consumption of the one or more functions may be reduced.

The indication that the door status has changed may be determined based on input from one or more sensors of the electronic door lock system. According to some aspects, the electronic door lock system includes one or more magnetometers that measure magnetic field strength. The electronic door lock system may further include a plurality of magnets disposed in a strike plate of the system such that measurements of magnetic field strength may be used to determine whether a status of the electronic lock (and by extension, the door) has changed.

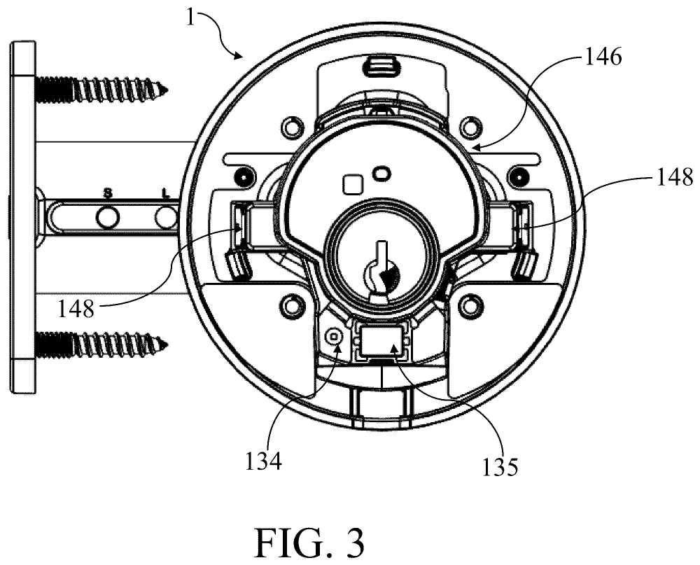

FIG. 3 illustrates a rear exterior view of an electronic lock of the example electronic door lock system of FIG. 2A having a front escutcheon removed, according to some embodiments of the technology described herein. With the front escutcheon of the electronic lock 1 removed, sensors of the electronic lock 1 can be seen. In the illustrated embodiment of FIG. 3, the electronic lock includes a pair of magnetometers 148. Magnetometers detect changes in magnetic field strength by measuring the voltage induced in a coil of a wire when a magnetic field passes through it. Relying on Faraday's law, the strength of the induced voltage is directly proportional to the strength of the magnetic field, allowing for measurement of field intensity by the magnetometer, and in some cases, direction of the magnetic field.

In the electronic lock 1, the pair of magnetometers may be used to detect a door status and/or a change in door status. The door status may be one of open or closed, in some embodiments. Accordingly, one or more measurements of magnetic field strength obtained by the magnetometer(s) of the electronic lock 1 are used to determine whether the door is open or closed. In particular, the external magnetic field measured by the magnetometer(s) is used to infer a current state of the door on which the electronic lock 1 is mounted. This is accomplished by placing a plurality of magnets in the strike plate 106. When the door is open, the distance between the magnetometer(s) and the plurality of magnets in the strike plate 106 causes the magnetic field strength to be less than when the door is closed, and the magnetometer(s) and the plurality of magnets in the strike plate are in close proximity to each other.

FIG. 3 illustrates an outer bezel 146 of the electronic lock 1. The outer bezel 146 surrounds the keyhole. The electronic lock 1 includes a pair of magnetometers 148 disposed inside the electronic lock 1, on the outer bezel 146. The pair of magnetometers 148 are disposed symmetrically about a plane intersecting the exterior face of the electronic lock 1. The pair of magnetometers may be placed as close to an exterior of the outer bezel as possible, to maximize the distance between the pair of magnetometers and internal ferromagnetic materials of the electronic lock.

The inventors have recognized that the use of two magnetometers as opposed to a single magnetometer in the electronic lock improves signal to noise ratio of the magnetic field strength measurements obtained by the magnetometer, thereby improving the accuracy of the door status detection. In some embodiments, each of the pair of magnetometers 148 may be configured to obtain one or more measurements of magnetic field strength, and the electronic door lock system 100 (e.g., the controller of the electronic door lock system 100) may be configured to use only the higher value magnetic field strength measurement when determining the door lock status. That is, the higher value magnetic field strength measurement can be assumed to be obtained from the magnetometer that is closest to the strike plate. In this way, the electronic lock 1 can be installed for right-or left-handed users without having to reposition the magnetometer within the electronic lock 1.

In some embodiments, the door status determined using the measurement(s) of magnetic field strength obtained by the magnetometer(s) may be a lock or unlock status. That is, the electronic door lock system 100 may use the magnetometer(s) to additionally or alternatively determine whether the door is locked or unlocked based on the detected magnetic field strength.

In further embodiments, the door status may comprise a change in door position. For example, a change in magnetic field strength may indicate that the door has moved, even if the door has not necessarily moved fully from open to close.

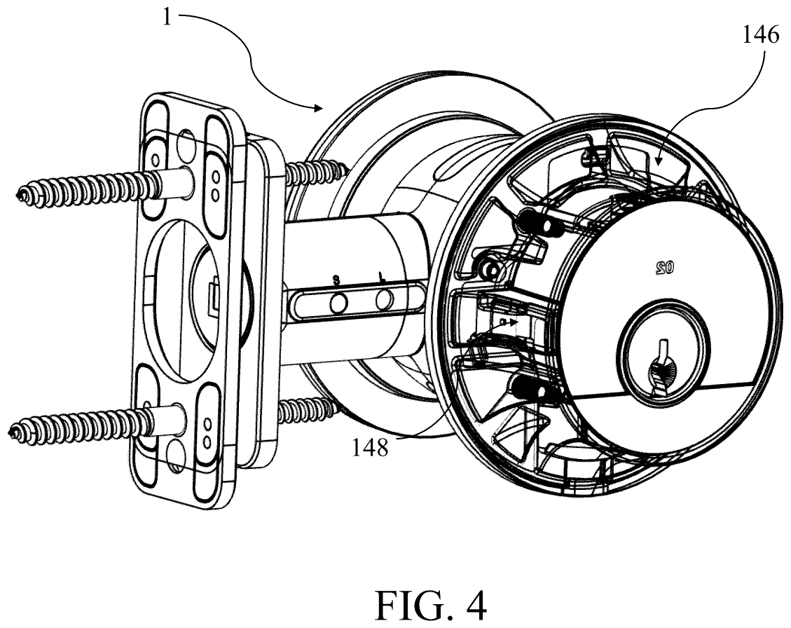

FIG. 4 illustrates a perspective view of the example electronic door lock system 100 of FIG. 2A where a portion of a housing of the electronic lock is transparent, according to some embodiments of the technology described herein. FIG. 4 provides a further view of the outer bezel 146 and the magnetometer 148 disposed thereon.

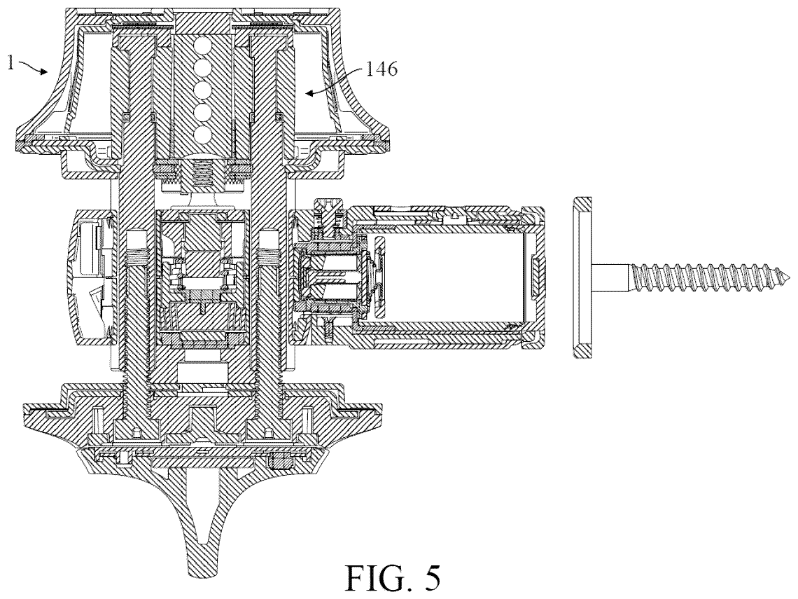

FIG. 5 illustrates a cross-sectional view taken along line 5-5 of FIG. 2F, according to some embodiments of the technology described herein. FIG. 5 provides a further view of the outer bezel 146 and the magnetometer 148 disposed thereon.

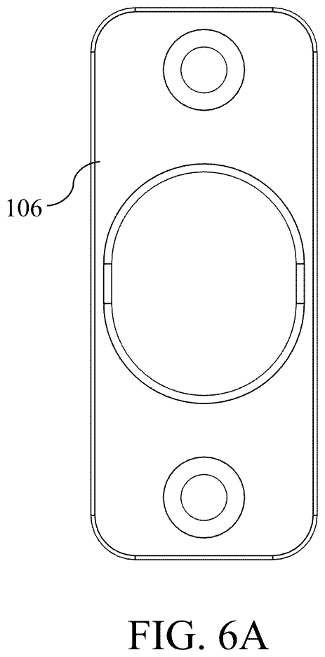

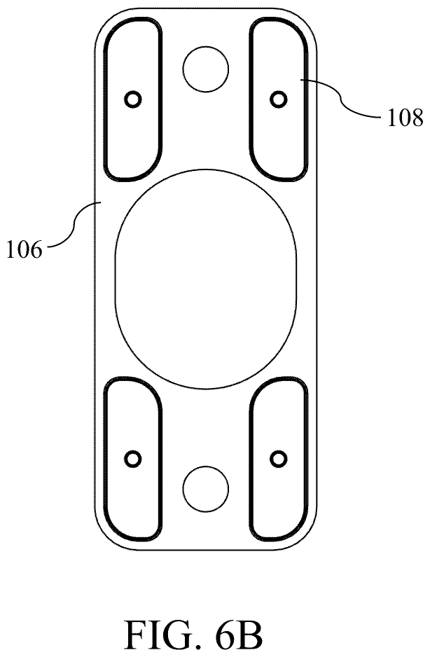

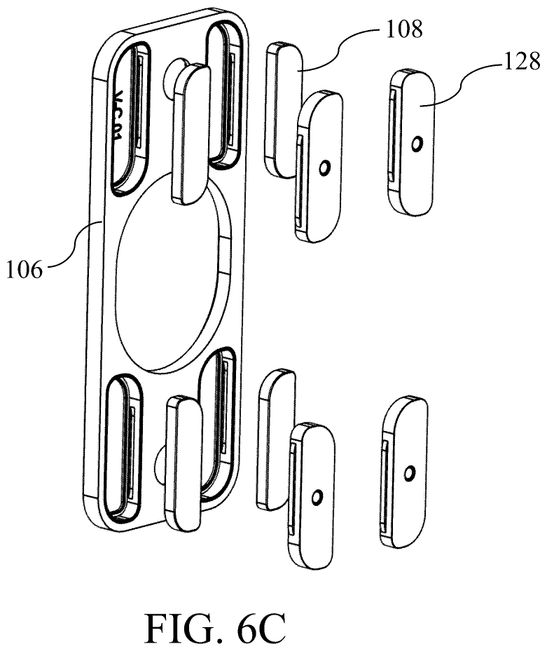

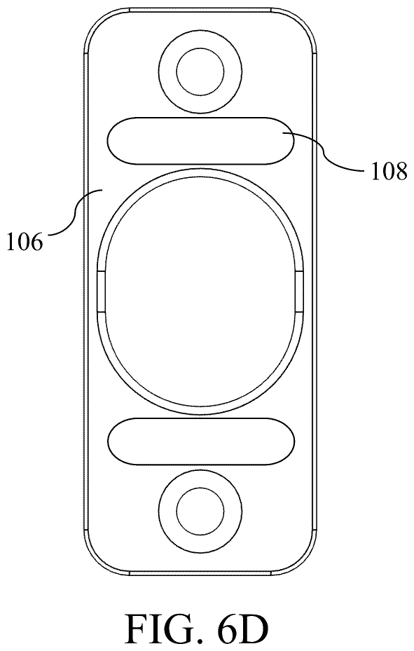

FIGS. 6A-6D illustrate example strike plates 106 of the electronic door lock system 100. FIG. 6A illustrates a front view of an example strike plate of the example electronic door lock system of FIG. 2A, according to some embodiments of the technology described herein. FIG. 6B illustrates a rear view of an example strike plate of FIG. 6A, according to some embodiments of the technology described herein.

As described herein, the strike plate 106 may include a plurality of magnets 108 disposed therein. In the illustrated embodiment of FIG. 6B, the plurality of magnets 108 include four magnets. The four magnets are symmetrically disposed in the strike plate. That is, the plurality of magnets 108 are arranged symmetrically about axes running vertically and horizontally down a center of the strike plate 106. In the illustrated embodiment, respective ones of the plurality of magnets 108 are disposed in respective corners of the strike plate 106.

FIG. 6C illustrates an exploded rear perspective view of the example strike plate of FIG. 6A, according to some embodiments of the technology described herein. In FIG. 6C, it can be seen that the plurality of magnets 108 are hidden from view within the strike plate 106. That is, in the illustrated embodiment of FIG. 6C, the plurality of magnets 108 are disposed on a rear face of the strike plate 108 and a rear cover 128 is placed over each of the plurality of magnets 108 such that the plurality of magnets 108 are not visible when the strike plate 106 is assembled.

FIG. 6D illustrates another example strike plate of an electronic door lock system, according to some embodiments of the technology described herein. In some embodiments, the plurality of magnets 108 include two magnets. In the illustrated embodiments of FIG. 6D, the two magnets 108 are disposed on a face of the strike plate 106 and are each covered by a cover. The two magnets 108 are arranged symmetrically about axes running vertically and horizontally through a center of the strike plate 106.

The inventors have recognized that the use of multiple magnets arranged symmetrically within the strike plate allow for the strike plate to be installed in any orientation while the magnetic field generated by the plurality of magnets in the strike plate remains the same.

Conventional door lock systems move magnetic material away the metal components of the electronic lock. In the example electronic door lock system described herein, however, the plurality of magnets are disposed within the strike plate. The strike plate may be made of non-ferromagnetic material so as not to interfere with the magnetic field generated by the plurality of magnets. In some embodiments, the non-ferromagnetic material may be nickel-based (e.g., P.A.N.A.C.E.A). The strike plate may include electroplating having a magnetic permeability that reduces the effects of external magnetic fields (e.g., from devices such as mobile devices including cell phones, watches, phone cases, etc.) but which still withstands environmental conditions. For example, the electroplating may be approximately 1.0 in magnetic permeability. The plurality of magnets may be made of sintered neodymium, for example.

Although in the illustrated embodiments, the one or more magnetometers are disposed in the electronic lock and the plurality of magnets are disposed in the strike plate, it should be understood that in some embodiments, one or more (e.g., a plurality of) magnets may be disposed in the electronic lock, and the one or more magnetometers may be disposed in the strike plate.

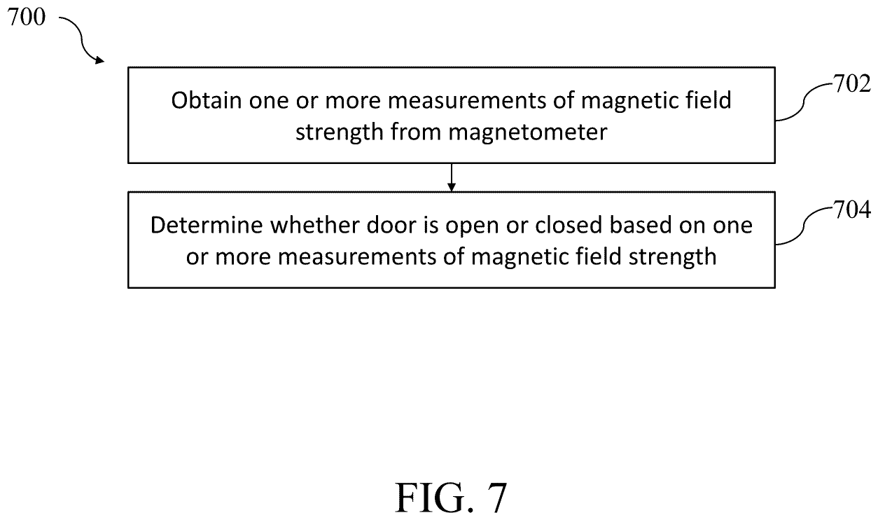

As described herein, the magnetometer(s) of the electronic lock may be used to obtain one or more measurements that may be used to detect a change in door status. FIG. 7 illustrates an example method for monitoring a position of a door coupled to an electronic door lock system, according to some embodiments of the technology described herein.

The example method of FIG. 7 begins at act 702, wherein one or more measurements of magnetic field strength are obtained from the magnetometer(s) of the electronic lock. Obtaining the one or more measurements may comprise obtaining a single measurement of magnetic field strength in some embodiments. In other embodiments, a plurality of magnetic field strength measurements may be obtained by a single magnetometer.

As described herein, the electronic lock may include a pair of magnetometers. In such embodiments, obtaining the one or more measurements of magnetic field strength at act 702 may comprise obtaining one or more measurements of magnetic field strength from each of the pair of magnetometers. In such embodiments, the electronic door lock system may be configured to determine which of the pair of magnetometers has obtained the highest value magnetic field strength measurements, and to disregard (e.g., by discarding the measurements) measurements from the other of the pair of magnetometers. In other embodiments, obtaining the one or more measurements of magnetic field strength at act 702 may comprise obtaining the one or more measurements of magnetic field strength from a single one of the pair of magnetometers.

At act 704, it is determined whether the door is open or closed based on the one or more measurements of magnetic field strength obtained at act 702. For example, it may be determined that the door is open when a difference between the magnetic field strength as measured by the one or more magnetometers and a calibration magnetic field strength is greater than a threshold (e.g., a magnetic field strength differential threshold). That is, the calibration magnetic field strength may be a magnetic field strength value that indicates that the door is closed. When the door is open, the magnetic field strength should be lower than the calibration magnetic field strength since the magnetometer is further away from the plurality of magnets in the strike plate when the door is open. Accordingly, if the measured magnetic field strength is less than the calibration magnetic field strength by a value that is greater than a threshold value, it may be determined that the door is open.

Similarly, the one or more measurements obtained by the magnetometer(s) may be used to determine that a position of the door has changed. The plurality of magnets generate a magnetic field that contributes to the magnetic field strength measured by the at least one magnetometer. For example, when the door moves closer to the strike plate, and closer to the closed position, the magnetic field strength detected by the magnetometer(s) increases, as the magnetometer(s) move closer to the plurality of magnets in the strike plate. When the door moves further from the strike plate, the magnetic field strength detected by the magnetometer(s) decreases, as the magnetometer(s) move away from the plurality of magnets in the strike plate. Accordingly a change in magnetic field strength detected by the magnetometers may be used to determine that the door has changed position.

As described herein, the electronic door lock system (e.g., the controller) may be configured to perform one or more actions in response to determining, based on act 704, that the door has changed position (e.g., from open to closed or vice versa), and/or that the lock has been locked or unlocked. The one or more actions may include controlling one or more sensors of the electronic door lock system to begin obtaining measurements and/or change a frequency (e.g., increase the frequency) at which measurements are obtained by the one or more sensors. In some embodiments, the one or more actions may include controlling the electronic door lock system to initiate and/or increase a frequency of wireless communications (e.g., Bluetooth, NFC) polling of the electronic door lock system. In this way, use of measurements of the magnetometer to control one or more actions of the electronic door lock system facilitates reduced energy consumption, by only performing the one or more actions until a change in door status has been detected, or performing the one or more actions at a reduced frequency until a change in door status has been detected.

Aspects of the technology described herein further provide for techniques of calibrating the one or more magnetometers of the electronic lock. Performing calibration of the one or more magnetometers of the electronic lock ensures that the measurements obtained by the one or more magnetometers remain accurate.

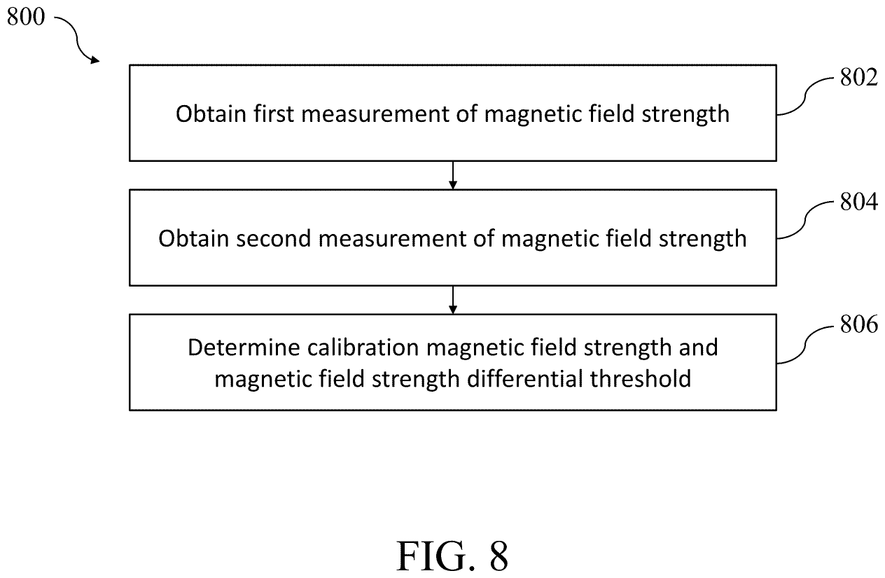

FIG. 8 illustrates an example method for calibration a magnetometer in an electronic lock of an electronic door lock system, according to some embodiments of the technology described herein.

The method 800 of FIG. 8 may begin at act 802 where a first measurement of magnetic field strength is obtained using at least one magnetometer of the electronic lock. In some embodiments, the first measurement of magnetic field strength may be obtained when the door is closed and the electronic lock is locked.

At act 804, a second measurement of magnetic field strength is obtained using the at least one magnetometer of the electronic lock. In some embodiments, the second measurement of magnetic field strength may be obtained when the door is closed and the electronic lock is unlocked. The first and second measurements thereby provide baseline magnetic field strengths when the door status of the door is known.

At act 806, a calibration magnetic field strength and a magnetic field strength differential threshold may be determined based on the first and second measurements obtained at acts 802-804. As described herein, the magnetic field strength differential threshold may indicate that the door is open when a magnetic field strength differential between a magnetic field strength measured by the at least one magnetometer and the calibration magnetic field strength exceeds the magnetic field strength differential threshold. The magnetic field strength differential threshold may be a value that is greater than the margin of error for the magnetic field strength measurement.

The calibration magnetic field strength may be a magnetic field strength that indicates the door is closed. For example, the calibration magnetic field strength may be determined at least in part by averaging the first and second measurements of magnetic field strength obtained at acts 802-804.

As described herein, the calibration magnetic field strength and the magnetic field strength differential threshold may be used to determine whether a present position of the door is open or closed by obtaining a present measurement of magnetic field strength using the one or more magnetometers. For example, the method 800 may further comprise, subsequent to the determining the magnetic field strength differential threshold at act 806, obtaining at least one third measurement of magnetic field strength and determining whether the door is open or closed at least in part by determining whether a difference between the at least one third measurement of magnetic field strength and the calibration magnetic field strength exceeds the magnetic field strength differential threshold. If the difference exceeds the threshold, it may be determined that the door is open. If the difference does not exceed the threshold, it may be determined that the door is closed.

According to some aspects of the technology described herein, there is provided techniques for compensating for drift of magnetometer measurements. For example, the inventors have recognized that the electronic lock described herein is vulnerable to drift, as unlike other locks which include a large amount of plastic, the electronic lock described herein includes materials exhibiting spontaneous magnetization in the presence of an external magnetic field. In addition, the electronic lock described herein is capable of performing wireless communications, including NFC, with a mobile device. For example, a mobile device such as a cell phone may be in close proximity with the electronic lock such that permanent magnets in the mobile device are presented to the electronic lock, thereby magnetizing the surrounding ferromagnetic materials in the electronic lock. The spontaneous magnetization of ferromagnetic materials in the electronic lock may cause the magnetic field strength measurements of the one or more magnetometers of the electronic lock to drift over time.

The drift may be compensated by applying filtering, such as long term filtering over time, of magnetic field strength measurements. The long term filtering may be applied to measurements of magnetic field strength obtained when the door is in a known door state (e.g., open or closed). In some embodiments, the long term filtering may be applied during a period of time where it is unlikely that the magnetometer is in use (e.g., during the night). In one example, the magnetic field strength may be sampled at 3 AM local time when the door is closed, and the resulting sample may be used (e.g., placed in a weighted moving average) to correct for drift induced by magnetization of the surrounding electronic lock materials. For example, the weighted average may include a proportion of historical data, the amount of which and weight of each data point may be tuned as desired. In some embodiments, more recently obtained data points may be weighted more heavily than prior obtained data points in the weighted average. While a weighted average is one example of how the periodic measurements can be used over time, other techniques can be used as well, including a traditional average, median, and/or the like.

In some embodiments, there is provided techniques for manufacturing the strike plate of the electronic door lock assembly. For example, the plurality of magnets may be first placed in the strike plate. Subsequently, the plurality of magnets may be fixed in place by performing injection molding. Finally, the plurality of magnets may be magnetized.

### IV. Techniques for Reducing Energy Consumption

As described herein, the electronic door lock system may be configured having features that reduce power consumption of the system including use of an indication that the door status has changed to control operation of the electronic lock. According to some embodiments, the determination that the door status has changed may be determined based on one or more measurements from an accelerometer.

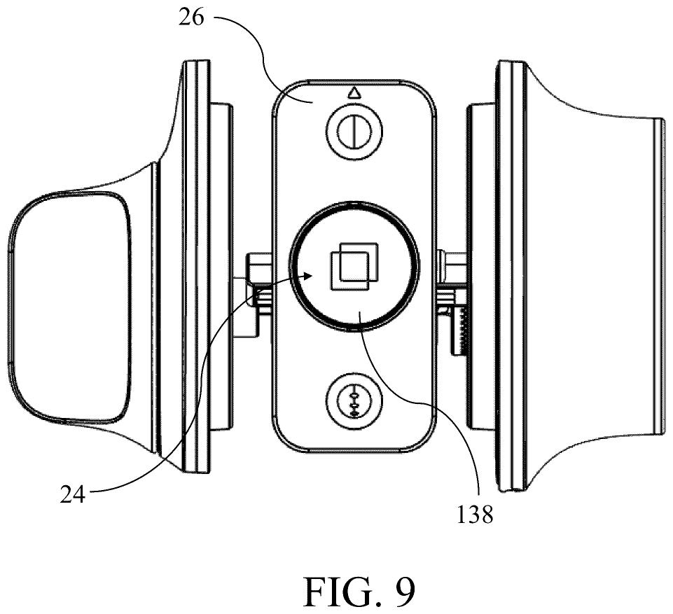

Accordingly, the one or more sensors 104 of the electronic door lock system 100 may include one or more accelerometers. The accelerometer(s) may be disposed on a body of the electronic lock 1. For example, FIG. 9 illustrates a side view of the electronic lock of FIG. 3 illustrating a deadbolt of the electronic lock, according to some embodiments of the technology described herein. In the illustrated embodiment of FIG. 9, an accelerometer 138 is coupled to the deadbolt 24 of the electronic lock. The placement of the accelerometer 138 on the deadbolt 24 enables the accelerometer to measure acceleration of the deadbolt 24. In some embodiments, the one or more accelerometers may be configured to measure acceleration of the deadbolt along three perpendicular axes (e.g., two axes along the plane of the door each perpendicular to each other, and a third axis perpendicular to the plane of the door). The measured acceleration of the deadbolt 24 may be used to determine an open or closed status of the door, additionally or alternatively may be used to determine a lock or unlocked status of the door, and additionally or alternatively may be used to determine an extended or retracted status of the deadbolt.

For example, based on detected acceleration along the length of the deadbolt 24, it may be determined that the deadbolt 24 has been moved between the extended and retracted positions. Based on detected acceleration along an axis through perpendicular to the length of the deadbolt, and perpendicular to a plane of the door, it may be determined that the deadbolt 24, and by extension the door, has been moved between open and closed status. If it is detected that the door is closed and the deadbolt is extended, it may be determined that the door is locked. Otherwise, it may be determined that the door is unlocked.

In some embodiments, the detected acceleration may be used to determine that a position of the door and/or deadbolt (e.g., a change in door state) has changed without necessarily determining whether the door is open or closed, or locked or unlocked. In such embodiments, one or more second sensors (e.g., one or more magnetometers) may be used to determine the open or closed status of the door, as described herein.

According to some aspects, operation of one or more components of the electronic door lock system may be controlled based on the change in door state detected based on the one or more measurements of acceleration obtained using the one or more accelerometers. For example, energy consumption of the electronic door lock system may be reduced by controlling operation of the one or more components of the electronic door lock system by causing the one or more components to begin operation or increase a frequency of operation in response to determining that the state of the door has changed. The one or more components may be one or more sensors, in some embodiments.

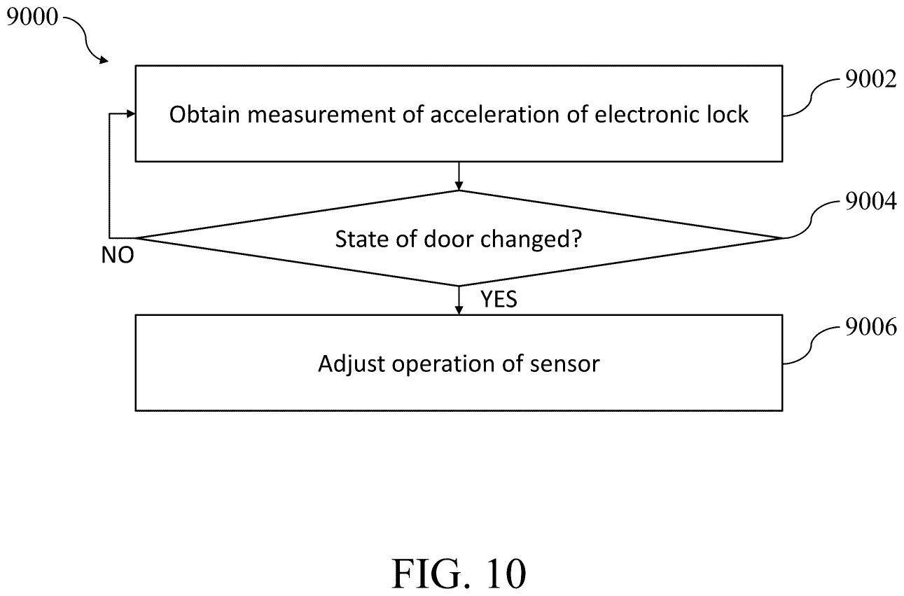

FIG. 10 illustrates an example method 9000 for controlling an electronic door lock system, according to some embodiments of the technology described herein. The example method 9000 may begin at act 9002 where one or more measurements of acceleration of the electronic lock is obtained. For example, the one or more measurements obtained at act 9002 may be obtained by one or more accelerometers of the electronic lock. In some embodiments, the one or more measurements obtained at act 9002 includes a single measurement of acceleration. In some embodiments, the one or more measurements obtained at act 9002 includes multiple measurements of acceleration.

In some embodiments, the one or more measurements of acceleration may include one or more measurements of acceleration forces. For example, the one or more measurements of acceleration forces may include one or more measurements of gravity (e.g., a gravity vector) and/or motion.

In some embodiments, the at least one accelerometer may be coupled to a deadbolt of the electronic lock. Accordingly, in some embodiments, the one or more measurements obtained at act 9002 may comprise one or more measurements of acceleration of the deadbolt.

At act 9004, it is determined, using the one or more measurements of acceleration obtained at act 9002, whether a state of the door has changed. As described herein, the change in the state of the door may comprise a change in position of the door and/or the deadbolt of the electronic lock. The change in position of the door may comprise a change between open and closed status of the door. In other embodiments, the change in position of the door may comprise a change in position of the door without a transition between open and closed status of the door. In some embodiments, the change in position of the deadbolt of the electronic lock may comprise between a locked and unlocked status of the electronic lock. In other embodiments, the change in position of the deadbolt may comprise a change in position of the deadbolt without a transition between locked and unlocked status of the electronic lock.

If it is determined, at act 9004 that the state of the door has not changed, the method 9000 may return through the NO branch to act 9002, or alternatively, end. If it is determined that the state of the door has changed, the method 9000 may proceed through the YES branch to act 9006. At act 9006, operation of one or more sensors that measure at least one characteristic of the electronic door lock system other than acceleration is adjusted. For example, adjusting the operation of the sensor may comprise controlling the sensor to obtain at least one measurement. That is, the adjusting the operation of the sensor may comprise controlling the sensor to initiate obtaining one or more measurements. In some embodiments, adjusting the operation of the sensor comprises adjusting (e.g., increasing) a frequency at which the sensor obtains measurements. In this way, energy consumption of the electronic door lock system can be reduced by initiating operation of the sensor or increasing the frequency at which the sensor operates in response to determining that a state of the door has changed based the obtained at least one measurement from the one or more accelerometers.

In one example, the one or more sensors comprise one or more magnetometers. The one or more magnetometers may be used to determine a present status or change in status of the door (e.g., open or closed). The method 1000 may include controlling the one or more magnetometers to begin or increase the frequency of obtaining measurements of magnetic field strength to determine the status of the door based on a determination that the state (e.g., position) of the door has changed based on one or more measurements of acceleration obtained by the accelerometer(s). In this way, energy consumption of the electronic door lock system is reduced, as the one or more magnetometers are operated at a reduced frequency until a change in door status is likely to have occurred based on the detected acceleration of the door.

### V. Presence Detection

According to some aspects of the technology described herein, the electronic door lock system is configured to detect the presence of a person in proximity of the electronic door lock system. In the illustrated embodiments of the technology described herein, presence detection is performed using a heat differential detected by one or more sensors of the electronic lock.

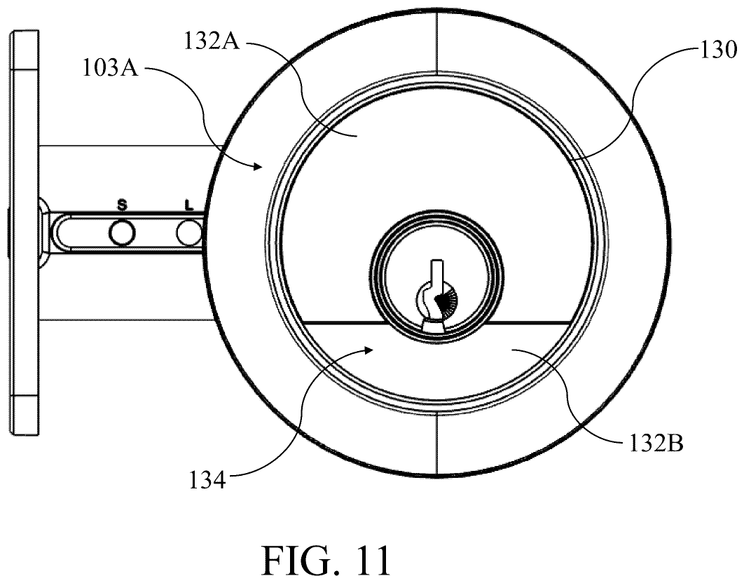

FIG. 11 illustrates a rear exterior view of the electronic lock of FIG. 3 illustrating aspects of a front escutcheon 130 of the electronic lock 1, according to some embodiments of the technology described herein. The front escutcheon 130 is placed on the exterior face 103A of the electronic lock 1 over internal components of the electronic lock 1, including the one or more sensors 104. In the illustrated embodiment of FIG. 11, the front escutcheon 130 is divided into two portions: an upper portion 132A and a lower portion 132B.

The lower portion 132B of the front escutcheon 130 may be disposed in front of a sensor 134 configured to measure a change in temperature in the proximity of the electronic lock. For example, the sensor 134 may comprise a passive infrared (PIR) sensor. In some embodiments, a lens may be disposed in front of the sensor. For example, the lens may be a Fresnel lens having a wide field of view which allows for sensing persons approaching from the side of the electronic lock in addition to persons approaching from the front of the electronic lock. Accordingly, the lower portion 132B may comprise a material that allows thermal infrared waves to pass through the lower portion 132B and be detected by the sensor. As an example, the lower portion 132B of the front escutcheon 130 may comprise a plastic, such as polyethylene, for example, high-density polyethylene.

While materials such as high-density polyethylene are advantageous as they allow thermal infrared waves to pass through the front escutcheon 130 to the sensor disposed behind the lower portion 132B, such materials are less robust and scratch-resistant. In the illustrated embodiment of FIG. 11, the front escutcheon 130 is divided into upper and lower portions 132A-B where the upper portion 132A is comprised of a different material than the lower portion 132B. In this way, the upper portion 132A can be made from material that is more robust and resistant to scratching than the lower portion 132B, as the upper portion 132A does not need to allow thermal infrared waves to pass through the front escutcheon 130. In some embodiments, the upper portion 132B may be made from a non-metal material, so as not to interfere with operations of the electronic lock (e.g., by avoiding inadvertent magnetization of the magnetometers as described herein, to enable NFC communications). For example, in some embodiments, the upper portion 132A may comprise glass.

It should be appreciated that in other embodiments, the lower portion 132B may comprise glass and/or the upper portion 132A may comprise a plastic, such as polyethylene. In some embodiments, each of the upper and lower portions 132A, 132B comprise a same material, such as glass or a plastic (e.g., polyethylene, including high density polyethylene) and/or a combination of materials. In some embodiments, the front escutcheon 130 may not be divided into the upper and lower portions 132A, 132B and may instead comprise a single face.

As described herein, detection of the presence of a person in proximity to the electronic door lock system is determined based on a heat differential measured by one or more sensors of the electronic lock, namely, sensor 134 shown in FIG. 11. For example, when a person approaches the electronic lock, the temperature in the proximity of the electronic lock increases. Detection of an increase in temperature (e.g., a positive heat differential) that exceeds a threshold indicates that a person is standing in front of the door. The heat differential may be a difference between first and second temperatures over two points in time as measured by the one or more sensors. A positive heat differential indicates an increase in temperature over the two points in time. The threshold heat differential may be a value that indicates a person has moved into the proximity of the electronic door lock system (e.g., based on a calibration performed on the electronic door lock system).

In some embodiments, the threshold heat differential may be adjusted (e.g., by a user, in some embodiments). For example, the threshold may vary based on the climate in which the electronic lock 1 is implemented.

In some embodiments, the electronic door lock system may be configured having a time period during which exceedances of the heat differential are ignored. In this way, detection of a heat differential above the threshold and therefore detection of the presence of a person in proximity to the electronic door lock system, do not trigger the adjusting of the operation of the electronic door lock system as described herein. For example, such a time period may include periods of time during the night, where it is unlikely that a person authorized to operate the electronic door lock system would approach the door.

In some embodiments, in addition to detecting the heat differential above the threshold, one or more additional conditions must be met before determining that a person is present in proximity of the electronic door lock system. The one or more additional conditions may include a determination the that heat differential has been above the threshold for a sustained period of time (e.g., 10 seconds). Accordingly, the heat differential must be detected for the sustained period of time in order to determine that a person is present in the proximity of the door. In this way, a person standing in front of the door may be distinguished from persons passing by the door who do not intend to operate the electronic lock. In some embodiments, the one or more additional conditions include a requisite number of times that the heat differential above the threshold must be detected before determining that the person is present in proximity of the electronic door lock system. For example, only when a requisite number of temperature measurements are obtained indicating the heat differential is above the threshold is it determined that the person is present in proximity of the electronic lock.

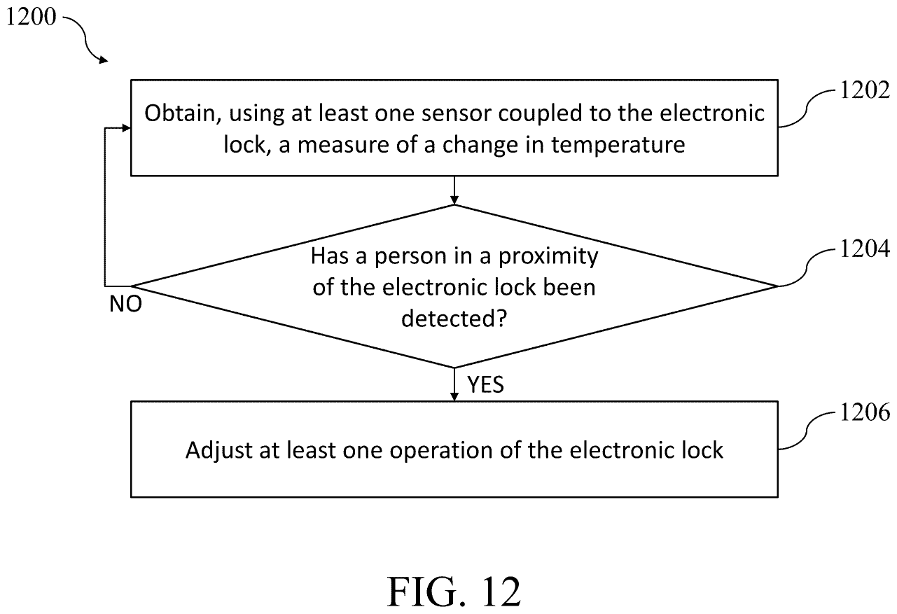

FIG. 12 illustrates another example method 1200 for controlling an electronic door lock system, according to some embodiments of the technology described herein. In the example method 1200, a measure of heat differential is used to detect the presence of a person in proximity of the electronic door lock system.

The method 1200 begins at act 1202, where a measure of a change in temperature (i.e., a heat differential) is obtained. Act 1202 may be performed using the sensor 134, as described herein.

At act 1204, it is determined whether a person in proximity of the electronic lock has been detected. As described herein, detecting whether a person is in proximity of the electronic door lock system may be performed using the measure of the heat differential. For example, in some embodiments, when the heat differential is greater than a threshold, it may be determined that a person is present in the proximity of the electronic door lock system.

If, at act 1204, it is determined that a person present in the proximity of the electronic door lock system has not been detected, the method 1200 may return through the NO branch to act 1202, or alternatively, may end. If, at act 1204, it is determined that a person present in the proximity of the electronic door lock system has been detected, the method 1200 may proceed through the YES branch to act 1206, where one or more operations of the electronic lock are adjusted.

For example, the detection of a person in proximity to the electronic door lock system may be used to adjust operation of the electronic door lock system. That is, the electronic door lock system may be controlled to perform one or more operations based on the determination that a person is in proximity to the electronic door lock system. In this way, energy consumption of the electronic door lock system can be reduced by only performing certain operations when it is determined that a person is in proximity to the electronic door lock system or performing the operations at a reduced frequency until a person is detected to be in proximity to the electronic door lock system.

As an example, a wireless communication advertising rate (e.g., BLE advertising rate, NFC wake-detection frequency) may be increased in response to determining that a person is in proximity to the electronic door lock system. That is, when a person approaches the electronic door lock system, it can be assumed that the person may wish to operate the electronic door lock system. Accordingly, the wireless communication advertising rate of the electronic door lock system may be increased to prepare for operation by the person. In some embodiments, the wireless communication advertising rate may be increased in response to other conditions, such as a door lock operation. In some embodiments, the increase in wireless communication advertising rate may be sustained for a fixed period of time (e.g., 10 seconds). If, after the fixed period of time it is detected that the person is no longer present int the proximity of the electronic door lock system, the wireless communication advertising rate may be decreased to the rate at which wireless communication advertising was performed prior to the presence detection. With the techniques for reduced power consumption described herein, the electronic door lock system requires less power to operate, thereby reducing the size of the power source for the electronic door lock system (e.g., fewer batteries) and the frequency at which the power source (e.g., batteries) is required to be replaced.

In some embodiments, adjusting operation of the electronic lock may include adjusting operation of at least one second sensor of the electronic door lock system that is configured to measure a characteristic of the electronic door lock system other than the change in temperature. For example, the at least one second sensor may comprise a magnetometer and/or an accelerometer. In some embodiments, the adjusting the operation of the at least one second sensor comprises controlling the at least one second sensor to obtain at least one measurement. In some embodiments, the adjusting the operation of the at least one second sensor comprises controlling the at least one second sensor to increase a frequency at which the at least one second sensor obtains measurements of the characteristic of the electronic door lock system.

### VI. Touch Detection

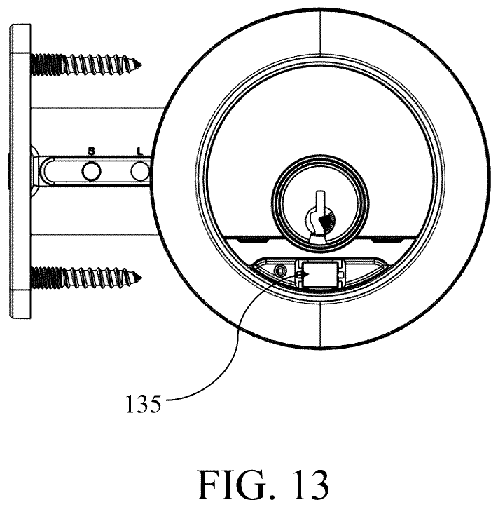

According to some aspects of the technology described herein, the electronic door lock system is configured to detect when a person has touched the electronic lock, and control the electronic lock door system based on the detected touch. FIG. 13 illustrates a rear exterior view of the electronic lock of FIG. 3, having a portion of a front escutcheon removed, according to some embodiments of the technology described herein. In particular, the lower portion 132B is removed in FIG. 13 to illustrate the sensor 135 disposed behind the lower portion 132B of the front escutcheon 130.

The sensor 135 is configured to detect when a person has touched the electronic lock 1, specifically, the lower portion 132B of the front escutcheon 130 of the electronic lock 1. For example, the sensor 135 may be a capacitive electrode that detects when a person has touched the lower portion 132B of the front escutcheon 130.

In some embodiments, the electronic lock may be configured to perform one or more actions in response to detecting that a person has touched the electronic lock. For example, the one or more actions may include locking the electronic lock and/or unlocking the electronic lock. In some embodiments, the unlocking the electronic lock may be coupled with an authentication. That is, the unlocking is performed based on detecting that a person has touched the electronic lock in addition to receiving a valid authentication indicating that the person is authorized to unlock the electronic lock. For example, the valid authentication may comprise a certain touch pattern (e.g., a predetermined number of taps to the lower portion 132B at a predetermined cadence). In some embodiments, the valid authentication may comprise a passkey received from a mobile device or via a keypad in communication with the electronic lock. In some embodiments, the valid authentication may comprise the detection of a known and authorized mobile device entering the proximity of the electronic door lock system (e.g., via detection using one or more geofences).

In some embodiments, the electronic lock may be configured such that the controlling based on the detected touch is performed only during certain times or under certain conditions. In such embodiments, the sensor 135 may not perform the touch detection when the conditions are not met. In other embodiments, the sensor 135 may detect touch at all times, but the electronic lock may not perform the one or more actions unless the conditions are met.

In some embodiments, the one or more conditions may include that it is a certain time of day (e.g., during the daytime). In some embodiments, the one or more conditions may include a change in door state (e.g., a change in position of the door, a change in lock or unlock status, a change in door open or close status). The change in door state may be detected by any of the techniques described herein, for example. In some embodiments, the one or more conditions may include detection of a person present in the proximity of the electronic lock. Based on the one or more conditions being met, the sensor may be controlled to detect touch and perform the one or more actions based on the detected touch. The sensor may be controlled in this way in response to the one or more conditions being met for a limited period of time, in some embodiments, (e.g., 10 seconds, 30 seconds, 60 seconds).

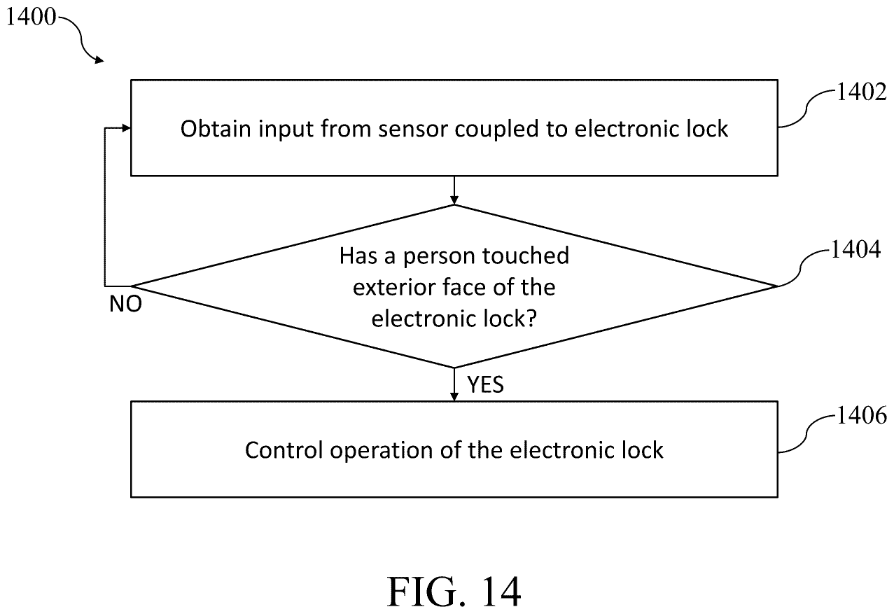

FIG. 14 illustrates another example method 1400 for controlling an electronic door lock system, according to some embodiments of the technology described herein. The method 1400 may begin at act 1402 where input from a sensor coupled to the electronic lock is received. As described herein, the input may be a touch input on the front escutcheon of the electronic lock, and the sensor may be configured to detect the touch input.

At act 1404, it is determined whether a person has touched the exterior face of the electronic lock. For example, act 1404 may be determined based on the input from the sensor received at act 1402. The exterior face may be the lower portion of the front escutcheon of the electronic lock.

If, at act 1404, it is not determined that a person has touched the exterior face of the electronic lock, the method 1400 may return through the NO branch to act 1402, or, alternatively, may end. If, at act 1404, it is determined that a person has touched the exterior face of the electronic lock, the method 1400 may proceed through the YES branch to act 1406. At act 1406, the operation of the electronic lock is controlled. Controlling the operation of the electronic lock based on the detection of touch may be performed as described herein, for example.

### VII. Example Computing System

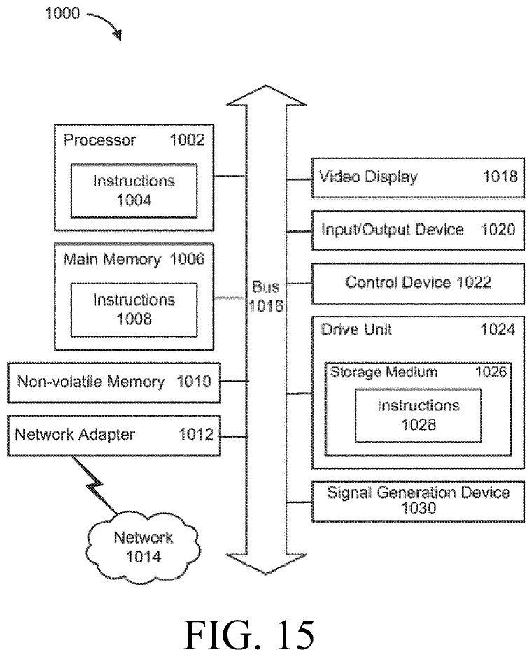

FIG. 15 is a block diagram illustrating an example of a processing system in which at least some operations described herein can be implemented. For example, some components of the processing system 1000 can be hosted on an electronic device as described in the present embodiments.

The processing system 1000 can include one or more central processing units (“processors”) 1002, main memory 1006, non-volatile memory 1010, network adapter 1012 (e.g., network interface), video display 1018, input/output devices 1020, control device 1022 (e.g., keyboard and pointing devices), drive unit 1024 including a storage medium 1026, and signal generation device 1030 that are communicatively connected to a bus 1016. The bus 1016 is illustrated as an abstraction that represents one or more physical buses and/or point-to-point connections that are connected by appropriate bridges, adapters, or controllers. The bus 1016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (i.e., “Firewire”).

The processing system 1000 can share a similar computer processor architecture as that of a desktop computer, tablet computer, personal digital assistant (PDA), smartphone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 1000.

While the main memory 1006, non-volatile memory 1010, and storage medium 1026 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1028. The term “machine-readable medium” and “storage medium” shall also be taken to include any medium that is capable of storing, encoding, or carrying a set of instructions for execution by the processing system 1000.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in a computing device. When read and executed by the one or more processors 1002, the instruction(s) cause the processing system 1000 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical disks (e.g., Compact Disk Read-Only Memory (CD-ROMS), Digital Versatile Disks (DVDs), and transmission-type media such as digital and analog communication links.

The network adapter 1012 enables the processing system 1000 to mediate data in a network 1014 with an entity that is external to the processing system 1000 through any communication protocol supported by the processing system 1000 and the external entity. The network adapter 1012 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1012 can include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### VIII. Example Embodiments

(1) An electronic door lock system comprising: an electronic lock configured to be coupled to a door, the electronic lock comprising at least one magnetometer; a strike plate configured to be coupled to a frame of the door, the strike plate having a plurality of magnets disposed therein; and at least one controller configured to determine whether the door is open or closed based on one or more measurements of magnetic field strength measured by the at least one magnetometer, wherein the plurality of magnets generate a magnetic field that contributes to the magnetic field strength measured by the at least one magnetometer.
(2) The electronic door lock system of (1), wherein the at least one magnetometer comprises a pair of magnetometers disposed on opposing sides of the electronic lock.
(3)The electronic door lock system of (1), wherein the at one magnetometer is coupled to an outer bezel of the electronic lock.
(4) The electronic door lock system of (1), wherein the plurality of magnets comprise two magnets.
(5) The electronic door lock system of (4), wherein the plurality of magnets comprise four magnets.
(6) The electronic door lock system of (5), wherein the plurality of magnets are symmetrically disposed in the strike plate.
(7) The electronic door lock system of (6), wherein respective ones of the plurality of magnets are disposed in respective corners of the strike plate.
(8) The electronic door lock system of (1), wherein the plurality of magnets are disposed internally within the strike plate, such that the plurality of magnets are not visible when the strike plate is assembled.
(9) The electronic door lock system of (8), wherein the plurality of magnets are disposed on a rear face of the strike plate and covered by a rear cover of the strike plate.
(10) The electronic door lock system of (1), wherein the at least one controller is configured to control the at least one magnetometer to obtain the one or more measurements and/or increase the frequency of obtaining the one or more measurements based on a determination that the door has moved and/or a determination that a lock status of the lock has changed.
(11) The electronic door lock system of (1), wherein the at least one controller is configured to determine whether the door is open or closed based on the one or more measurements of the at least one magnetometer at least in part by determining whether a difference between the one or more measurements and a calibration magnetic field strength exceeds a magnetic field strength differential threshold.
(12) The electronic door lock system of (11), wherein the at least one controller is configured to determine that the door is open when the difference between the one or more measurements and the calibration magnetic field strength exceed the magnetic field strength differential threshold.
(13) The electronic door lock system of (1), wherein the at least one controller is further configured to, based on the one or more measurements of the at least one magnetometer, determine that a position of the door has changed.
(14) A method of monitoring a position of a door coupled to an electronic door lock system, the method comprising: obtaining one or more measurements of magnetic field strength from at least one magnetometer of an electronic lock of the electronic door lock system coupled to the door, the electronic door lock system further comprising a strike plate coupled to a frame of the door and having a plurality of magnets disposed therein, wherein the plurality of magnets generate a magnetic field that contributes to the magnetic field strength measured by the at least one magnetometer; and determining whether the door is open or closed based on the one or more measurements of magnetic field strength of the at least one magnetometer.
(15) The method of (14), wherein the at least one magnetometer comprises a pair of magnetometers disposed on opposing sides of the electronic lock.
(16) The method of any of (14)-(15), wherein the at one magnetometer is coupled to an outer bezel of the electronic lock.
(17) The method of any of (14)-(16), wherein the plurality of magnets comprise two magnets.
(18) The method of (17), wherein the plurality of magnets comprise four magnets.
(19) The method of (18), wherein the plurality of magnets are symmetrically disposed in the strike plate.
(20) The method of (19), wherein respective ones of the plurality of magnets are disposed in respective corners of the strike plate.
(21) The method of any of (14)-(20), wherein the plurality of magnets are disposed internally within the strike plate, such that the plurality of magnets are not visible when the strike plate is assembled.
(22) The method of (21), wherein the plurality of magnets are disposed on a rear face of the strike plate and covered by a rear cover of the strike plate.
(23) The method of any of (14)-(22), further comprising controlling the at least one magnetometer to obtain the one or more measurements and/or increase the frequency of obtaining the one or more measurements based on a determination that the door has moved and/or a determination that a lock status of the lock has changed.
(24) The method of any of (14)-(23), wherein the determining whether the door is open or closed based on the one or more measurements of the at least one magnetometer comprises determining whether a difference between the one or more measurements and a calibration magnetic field strength exceeds a magnetic field strength differential threshold.
(25) The method of (24), further comprising determining that the door is open when the difference between the one or more measurements and the calibration magnetic field strength exceed the magnetic field strength differential threshold.
(26) The method of any of (14)-(25), further comprising, based on the one or more measurements of the at least one magnetometer, determine that a position of the door has changed.
(27) At least one non-transitory computer-readable storage medium having instructions encoded thereon that, when executed by at least one processor, cause the at least one processor to perform a method of monitoring a position of a door coupled to an electronic door lock system, the method comprising: obtaining one or more measurements of magnetic field strength from at least one magnetometer of an electronic lock of the electronic door lock system coupled to the door, the electronic door lock system further comprising a strike plate coupled to a frame of the door and having a plurality of magnets disposed therein, wherein the plurality of magnets generate a magnetic field that contributes to the magnetic field strength measured by the at least one magnetometer; and determining whether the door is open or closed based on the one or more measurements of magnetic field strength of the at least one magnetometer.
(28) The at least one non-transitory computer-readable storage medium of (27), wherein the method is the method of any of (15)-(26).
(29) A method of calibrating at least one magnetometer in an electronic lock of an electronic door lock system, the electronic door lock system further comprising a strike plate coupled to a frame of the door and having a plurality of magnets disposed therein, the method comprising: obtaining at least one first measurement of magnetic field strength and at least one second measurement of magnetic field strength using the at least one magnetometer; and determining, based on the at least one first measurement and at least one second measurement, a calibration magnetic field strength and a magnetic field strength differential threshold that indicates the door is open when a magnetic field strength differential between a magnetic field strength measured by the at least one magnetometer and the calibration magnetic field strength exceeds the magnetic field strength differential threshold.
(30) The method of (29), wherein obtaining the at least one first measurement of magnetic field strength and the at least one second measurement of magnetic field strength comprises: obtaining the at least one first measurement of magnetic field strength measured by the at least one magnetometer when the door is closed and a deadbolt of the electronic lock is locked such that the deadbolt extends through an opening in the strike plate; and obtaining the at least one second measurement of magnetic field strength measured by the at least one magnetometer when the door is closed and a deadbolt of the door is unlocked.
(31) The method of any one of (29)-(30), wherein the calibration magnetic field strength is a magnetic field strength that indicates the door is closed.
(32) The method of any one of (29)-(31), wherein determining the calibration magnetic field strength comprises determining an average of the at least one first measurement and the at least one second measurement.
(33) The method of any one of (29)-(32), wherein the at least one magnetometer comprises a pair of magnetometers disposed on opposing sides of the electronic lock.
(34) The method of any one of (29)-(33), wherein the at least one magnetometer is coupled to an outer bezel of the electronic lock.
(35) The method of any one of (29)-(34), wherein the plurality of magnets comprise two magnets.
(36) The method of (35), wherein the plurality of magnets comprise four magnets.
(37) The method of (36), wherein the plurality of magnets are symmetrically disposed in the strike plate.
(38) The method of (37), wherein respective ones of the plurality of magnets are disposed in respective corners of the strike plate.
(39) The method of any one of (29)-(38), wherein the plurality of magnets are disposed internally within the strike plate, such that the plurality of magnets are not visible when the strike plate is assembled.
(40) The method of any one of (29)-(39), wherein the plurality of magnets are disposed on a rear face of the strike plate and covered by a rear cover of the strike plate.
(41) The method of any one of (29)-(40), further comprising, subsequent to the determining the magnetic field strength differential threshold: obtaining at least one third measurement of magnetic field strength; and determining whether the door is open or closed at least in part by determining whether a difference between the at least one third measurement of magnetic field strength and the calibration magnetic field strength exceeds the magnetic field strength differential threshold.
(42) The method of (41), further comprising adjusting, prior to the determining whether the door is open or closed, the at least one third measurement of magnetic field strength to correct the at least one third measurement of magnetic field strength for drift.
(43) The method of (42), wherein the adjusting the at least one third measurement of magnetic field strength comprises applying a correction to the at least one third measurement of magnetic field strength, and the method further comprises determining the correction at least in part by filtering measurements of magnetic field strength obtained when the door is closed and locked.
(44) An electronic door lock system comprising: an electronic lock configured to be coupled to a door and comprising at least one magnetometer; a strike plate configured to be coupled to a frame of the door and comprising a plurality of magnets; at least one controller; and at least one non-transitory computer-readable storage medium having encoded thereon instructions that, when executed by the at least one controller, cause the at least one controller to perform a method for calibrating the at least one magnetometer, the method comprising: obtaining at least one first measurement of magnetic field strength and at least one second measurement of magnetic field strength using the at least one magnetometer; and determining, based on the at least one first measurement and at least one second measurement, a calibration magnetic field strength and a magnetic field strength differential threshold that indicates the door is open when a magnetic field strength differential between a magnetic field strength measured by the at least one magnetometer and the calibration magnetic field strength exceeds the magnetic field strength differential threshold.
(45) The electronic door lock system of (44), wherein obtaining the at least one first measurement of magnetic field strength and the at least one second measurement of magnetic field strength comprises: obtaining the at least one first measurement of magnetic field strength measured by the at least one magnetometer when the door is closed and a deadbolt of the electronic lock is locked such that the deadbolt extends through an opening in the strike plate; and obtaining the at least one second measurement of magnetic field strength measured by the at least one magnetometer when the door is closed and a deadbolt of the door is unlocked.
(46) The electronic door lock system of any one of (44)-(45), wherein the calibration magnetic field strength is a magnetic field strength that indicates the door is closed.
(47) The electronic door lock system of any one of (44)-(46), wherein determining the calibration magnetic field strength comprises determining an average of the at least one first measurement and the at least one second measurement.
(48) The electronic door lock system of any one of (44)-(47), wherein the at least one magnetometer comprises a pair of magnetometers disposed on opposing sides of the electronic lock.
(49) The electronic door lock system of any one of (44)-(48), wherein the at least one magnetometer is coupled to an outer bezel of the electronic lock.
(50) The electronic door lock system of any one of (44)-(49), wherein the plurality of magnets comprise two magnets.
(51) The electronic door lock system of (50), wherein the plurality of magnets comprise four magnets.
(52) The electronic door lock system of (51), wherein the plurality of magnets are symmetrically disposed in the strike plate.
(53) The electronic door lock system of (52), wherein respective ones of the plurality of magnets are disposed in respective corners of the strike plate.
(54) The electronic door lock system of any one of (44)-(53), wherein the plurality of magnets are disposed internally within the strike plate, such that the plurality of magnets are not visible when the strike plate is assembled.
(55) The electronic door lock system of any one of (44)-(54), wherein the plurality of magnets are disposed on a rear face of the strike plate and covered by a rear cover of the strike plate.
(56) The electronic door lock system of any one of (44)-(55), wherein the method further comprises, subsequent to the determining the magnetic field strength differential threshold: obtaining at least one third measurement of magnetic field strength; and determining whether the door is open or closed at least in part by determining whether a difference between the at least one third measurement of magnetic field strength and the calibration magnetic field strength exceeds the magnetic field strength differential threshold.
(57) The electronic door lock system of (46), wherein the method further comprises adjusting, prior to the determining whether the door is open or closed, the at least one third measurement of magnetic field strength to correct the at least one third measurement of magnetic field strength for drift.
(58) The electronic door lock system of (47), wherein the adjusting the at least one third measurement of magnetic field strength comprises applying a correction to the at least one third measurement of magnetic field strength, and the method further comprises determining the correction at least in part by filtering measurements of magnetic field strength obtained when the door is closed and locked.
(59) At least one non-transitory computer-readable storage medium having instructions encoded thereon, that when executed by at least one processor, cause the at least one processor to perform a method of calibrating at least one magnetometer in an electronic lock of an electronic door lock system, the electronic door lock system further comprising a strike plate coupled to a frame of the door and having a plurality of magnets disposed therein, the method comprising: obtaining at least one first measurement of magnetic field strength and at least one second measurement of magnetic field strength using the at least one magnetometer; and determining, based on the at least one first measurement and at least one second measurement, a calibration magnetic field strength and a magnetic field strength differential threshold that indicates the door is open when a magnetic field strength differential between a magnetic field strength measured by the at least one magnetometer and the calibration magnetic field strength exceeds the magnetic field strength differential threshold.
(60) The at least one non-transitory computer-readable storage medium of (59, wherein the method is the method of any of (29)-(43).
(61) An electronic door lock system comprising: an electronic lock configured to be coupled to a door, the electronic lock comprising: at least one accelerometer coupled to the electronic lock and configured to measure acceleration of the electronic lock; at least one sensor configured to measure a characteristic of the electronic door lock system other than the acceleration of the electronic lock; and at least one controller configured to: determine, based on at least one measurement obtained using the at least one accelerometer, whether a state of the door has changed; and in response to determining that the state of the door has changed, adjust operation of the at least one sensor.
(62) The electronic door lock system of (61), wherein the state of the door comprises a position of the door.
(63) The electronic door lock system of any of (61)-(62), wherein the state of the door comprises a locked or unlocked state.
(64) The electronic door lock system of any of (61)-(63), wherein the state of the door comprises an open or closed state.
(65) The electronic door lock system of any of (61)-(64), wherein the at least one accelerometer is configured to measure the acceleration of the electronic lock along three perpendicular axes.
(66) The electronic door lock system of any of (61)-(65), wherein the at least one sensor comprises at least one magnetometer and the characteristic of the electronic door lock system comprises a magnetic field strength detected by the at least one magnetometer.
(67) The electronic door lock system of (66), wherein the at least one magnetometer comprises a pair of magnetometers disposed on opposing sides of the electronic lock.
(68) The electronic door lock system of (66), wherein the at least one magnetometer is disposed on an outer bezel of the electronic lock.
(69) The electronic door lock system of (66), further comprising a strike plate configured to be coupled to a frame of the door and comprising a plurality of magnets disposed therein.
(70) The electronic door lock system of any of (61)-(69), wherein the adjusting the operation of the at least one sensor comprises controlling the at least one sensor to obtain at least one measurement.
(71) The electronic door lock system of any of (61)-(70), wherein the adjusting the operation of the at least one sensor comprises controlling the at least one sensor to increase a frequency at which the at least one sensor obtains measurements of the characteristic of the electronic door lock system.
(72) The electronic door lock system of any of (61)-(71), wherein the at least one accelerometer is coupled to a deadbolt of the electronic lock and the at least one accelerometer is configured to measure acceleration of the deadbolt.
(73) A method for controlling an electronic door lock system comprising an electronic lock configured to be coupled to a door, the method comprising: obtaining, from at least one accelerometer of the electronic lock coupled to the electronic lock, at least one measurement of acceleration of the electronic lock; determining, based on the at least one measurement obtained using the at least one accelerometer, whether a state of the door has changed; and in response to determining that the state of the door has changed, adjusting operation of at least second sensor of the electronic lock configured to measure a characteristic of the electronic door lock system other than the acceleration of the electronic lock.
(74) The method of (73), wherein the state of the door comprises a position of the door.
(75)The method of any of (73)-(74), wherein the state of the door comprises a locked or unlocked state.
(76) The method of any of (73)-(75), wherein the state of the door comprises an open or closed state.
(77) The method of any of (73)-(76), wherein the at least one accelerometer is configured to measure the acceleration of the electronic lock along three perpendicular axes.
(78) The method of any of (73)-(77), wherein the at least one sensor comprises at least one magnetometer and the characteristic of the electronic door lock system comprises a magnetic field strength detected by the at least one magnetometer.
(79) The method of (78), wherein the at least one magnetometer comprises a pair of magnetometers disposed on opposing sides of the electronic lock.
(80) The method of (78), wherein the at least one magnetometer is disposed on an outer bezel of the electronic lock.
(81) The method of (78), further comprising a strike plate configured to be coupled to a frame of the door and comprising a plurality of magnets disposed therein.
(82) The method of any of (73)-(81), wherein the adjusting the operation of the at least one sensor comprises controlling the at least one sensor to obtain at least one measurement.
(83) The method of any of (73)-(82), wherein the adjusting the operation of the at least one sensor comprises controlling the at least one sensor to increase a frequency at which the at least one sensor obtains measurements of the characteristic of the electronic door lock system.
(84) The method of any of (73)-(83), wherein the at least one accelerometer is coupled to a deadbolt of the electronic lock and the at least one accelerometer is configured to measure acceleration of the deadbolt.
(85) At least one non-transitory computer-readable storage medium having instructions encoded thereon that, when executed by at least one processor, cause the at least one processor to perform a method for controlling an electronic door lock system comprising an electronic lock configured to be coupled to a door, the method comprising: obtaining, from at least one accelerometer of the electronic lock coupled to the electronic lock, at least on measurement of acceleration of the electronic lock; determining, based on the at least one measurement obtained using the at least one accelerometer, whether a state of the door has changed; and in response to determining that the state of the door has changed, adjusting operation of at least second sensor of the electronic lock configured to measure a characteristic of the electronic door lock system other than the acceleration of the electronic lock.
(86) The at least one non-transitory computer-readable storage medium of (85, wherein the method is the method of any of (74)-(84).
(87) An electronic door lock system comprising: an electronic lock configured to be coupled to a door; at least one sensor coupled to the electronic lock and configured to sense a change in temperature; and at least one controller configured to: obtain, using the at least one sensor, a measure of the change in temperature; determine, based on the measure of the change in temperature, whether a person is in a proximity of the electronic lock; and based on determining that a person is in a proximity of the electronic lock, adjust at least one operation of the electronic lock.
(88) The electronic door lock system of (87), wherein the at least one sensor comprises at least one passive infrared (PIR) sensor.
(89) The electronic door lock system of (88), further comprising a lens disposed in front of the at least one PIR sensor, and a plate disposed between the lens and an exterior of the electronic lock.
(90) The electronic door lock system of (89), wherein the lens comprises a Fresnel lens.
(91) The electronic door lock of any one of (87)-(90), wherein the determining comprises determining that the person is in the proximity of the electronic lock when the change in temperature exceeds a threshold.
(92) The electronic door lock system of (91), wherein the change in temperature comprises a positive change in temperature.
(93) The electronic door lock system of any one of (87)-(92), wherein adjusting the at least one operation of the electronic lock comprises increasing a frequency of wireless communications polling performed by the electronic lock.
(94) The electronic door lock system of (93), wherein the wireless communications polling comprises Bluetooth polling and/or near-field communication (NFC) polling.
(95) The electronic door lock system of any one of (87)-(94), further comprising at least one second sensor configured to measure a characteristic of the electronic door lock system other than the change in temperature and adjusting the operation of the electronic lock comprises adjusting operation of the at least one second sensor.
(96) The electronic door lock system of (95), wherein the at least one second sensor comprises at least one magnetometer.
(97) The electronic door lock system of (95), wherein the at least one second sensor comprises at least one accelerometer.
(98) The electronic door lock system of (95), wherein the adjusting the operation of the at least one second sensor comprises controlling the at least one second sensor to obtain at least one measurement.
(99) The electronic door lock system of (95), wherein the adjusting the operation of the at least one second sensor comprises controlling the at least one second sensor to increase a frequency at which the at least one second sensor obtains measurements of the characteristic of the electronic door lock system.
(100) A method for controlling an electronic door lock system comprising an electronic lock configured to be coupled to a door, the method comprising: obtaining, using at least one sensor coupled to the electronic lock, a measure of a change in temperature; determining, based on the measure of the change in temperature, whether a person is in a proximity of the electronic lock; and based on determining that a person is in a proximity of the electronic lock, adjusting at least one operation of the electronic lock.
(101) The method of (100), wherein the at least one sensor comprises at least one passive infrared (PIR) sensor.
(102) The method of (101), wherein the electronic lock further comprises a lens disposed in front of the at least one PIR sensor, and a plate disposed between the lens and an exterior of the electronic lock.
(103) The method of (102), wherein the lens comprises a Fresnel lens.
(104) The electronic door lock of any one of (100)-(102), wherein the determining comprises determining that the person is in the proximity of the electronic lock when the change in temperature exceeds a threshold.
(105) The method of (104), wherein the change in temperature comprises a positive change in temperature.
(106) The method of any one of (100)-(105), wherein adjusting the at least one operation of the electronic lock comprises increasing a frequency of wireless communications polling performed by the electronic lock.
(107) The method of (106), wherein the wireless communications polling comprises Bluetooth polling and/or near-field communication (NFC) polling.
(108) The method of any one of (100)-(107), wherein the electronic lock further comprises at least one second sensor configured to measure a characteristic of the electronic lock other than the change in temperature and adjusting the operation of the electronic lock comprises adjusting operation of the at least one second sensor.
(109) The method of (108), wherein the at least one second sensor comprises at least one magnetometer.
(110) The method of (108), wherein the at least one second sensor comprises at least one accelerometer.
(111) The method of (108), wherein the adjusting the operation of the at least one second sensor comprises controlling the at least one second sensor to obtain at least one measurement.
(112) The method of (108), wherein the adjusting the operation of the at least one second sensor comprises controlling the at least one second sensor to increase a frequency at which the at least one second sensor obtains measurements of the characteristic of the electronic lock.
(113) At least one non-transitory computer-readable storage medium having instructions encoded thereon that, when executed by at least one processor, cause the at least one processor to perform a method for controlling an electronic door lock system comprising an electronic lock configured to be coupled to a door, the method comprising: obtaining, using at least one sensor coupled to the electronic lock, a measure of a change in temperature; determining, based on the measure of the change in temperature, whether a person is in a proximity of the electronic lock; and based on determining that a person is in a proximity of the electronic lock, adjusting at least one operation of the electronic lock.
(114) The at least one non-transitory computer-readable storage medium of (113, wherein the method is the method of any of (101)-(112).
(115) An electronic door lock system comprising: an electronic lock configured to be coupled to a door, wherein the electronic lock comprises an interior face that faces an interior of a space when the electronic lock is coupled to the door of the space and an exterior face opposite the interior face; at least one sensor disposed on the exterior face, wherein the at least one sensor is configured to detect that a person has touched the exterior face of the electronic lock; and at least one controller configured to control the electronic lock based on the at least one sensor detecting that the person has touched the exterior face of the electronic lock.
(116) The electronic door lock system of (115), wherein the at least one sensor comprises a capacitive electrode.
(117) The electronic door lock system of any one of (115)-(116), wherein controlling the electronic lock comprises locking the electronic lock based on the at least one sensor detecting that the person has touched the exterior face of the electronic lock.
(118) The electronic door lock system of any one of (115)-(117), wherein the controlling the electronic lock comprises locking the electronic lock based on the at least one sensor detecting that the person has touched the exterior face of the electronic lock and responsive to determining that the electronic lock was unlocked within a threshold time limit.
(119) The electronic door lock system of any one of (115)-(118), wherein the controlling the electronic lock comprises locking the electronic lock based on the at least one sensor detecting that the person has touched the exterior face of the electronic lock and responsive to determining that the door was opened within a threshold time limit.
(120) The electronic door lock system of any one of (115)-(119), wherein the controlling the electronic lock comprises locking the electronic lock based on the at least one sensor detecting that the person has touched the exterior face of the electronic lock and responsive to determining that a valid credential has been received by the electronic door lock system within a threshold time limit.
(121) The electronic door lock system of any one of (115)-(120), wherein the controlling the electronic lock comprises locking the electronic lock based on the at least one sensor detecting that the person has touched the exterior face of the electronic lock and responsive to determining that a person has been detected within a proximity of the electronic lock within a threshold time limit.
(122) The electronic door lock system of any one of (115)-(121), wherein the controlling the electronic lock comprises locking the electronic lock based on the at least one sensor detecting that the person has touched the exterior face of the electronic lock and responsive to determining a position of the door has changed within a threshold time limit.
(123) A method of controlling an electronic door lock system comprising an electronic lock configured to be coupled to a door, wherein the electronic lock comprises an interior face that faces an interior of a space when the electronic lock is coupled to the door of the space and an exterior face opposite the interior face, the method comprising: detecting, using at least one sensor disposed on the exterior face, that a person has touched the exterior face of the electronic lock; and controlling the electronic lock based on the at least one sensor detecting that the person has touched the exterior face of the electronic lock.
(124) The method of (123), wherein the at least one sensor comprises a capacitive electrode.
(125) The method of any one of (123)-(124), wherein controlling the electronic lock comprises locking the electronic lock based on the at least one sensor detecting that the person has touched the exterior face of the electronic lock.
(126) The method of any one of (123)-(125), wherein the controlling the electronic lock comprises locking the electronic lock based on the at least one sensor detecting that the person has touched the exterior face of the electronic lock and responsive to determining that the electronic lock was unlocked within a threshold time limit.
(127) The method of any one of (123)-(126), wherein the controlling the electronic lock comprises locking the electronic lock based on the at least one sensor detecting that the person has touched the exterior face of the electronic lock and responsive to determining that the door was opened within a threshold time limit.
(128) The method of any one of (123)-(127), wherein the controlling the electronic lock comprises locking the electronic lock based on the at least one sensor detecting that the person has touched the exterior face of the electronic lock and responsive to determining that a valid credential has been received by the electronic door lock system within a threshold time limit.
(129) The method of any one of (123)-(128), wherein the controlling the electronic lock comprises locking the electronic lock based on the at least one sensor detecting that the person has touched the exterior face of the electronic lock and responsive to determining that a person has been detected within a proximity of the electronic lock within a threshold time limit.
(130) The method of any one of (123)-(129), wherein the controlling the electronic lock comprises locking the electronic lock based on the at least one sensor detecting that the person has touched the exterior face of the electronic lock and responsive to determining a position of the door has changed within a threshold time limit.
(131) At least one non-transitory computer-readable storage medium having instructions encoded thereon that, when executed by at least one processor, cause the at least one processor to perform a method for controlling an electronic door lock system comprising an electronic lock configured to be coupled to a door, wherein the electronic lock comprises an interior face that faces an interior of a space when the electronic lock is coupled to the door of the space and an exterior face opposite the interior face, the method comprising: detecting, using at least one sensor disposed on the exterior face, that a person has touched the exterior face of the electronic lock; and controlling the electronic lock based on the at least one sensor detecting that the person has touched the exterior face of the electronic lock.
(132) The at least one non-transitory computer-readable storage medium of (131), wherein the method is the method of any of (124)-(130).

### IX. Equivalents and Scope

Embodiments of the above-described techniques can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. In some embodiments, the functions performed by one or more controllers and/or processors described herein may be implemented as software executed on one or more processors.

Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the technology described herein. For example, any one or more of the methods described herein may be implemented in at least one non-transitory computer-readable storage medium having instructions encoded thereon, that, when executed by at least one processor, cause the at least one processor to perform the one or more methods. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present technology as described above. As used herein, the term “computer-readable storage medium” encompasses only a computer-readable medium that can be considered to be a manufacture (i.e., article of manufacture) or a machine. Alternatively or additionally, the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of technology described herein. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present technology may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, examples of which have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various events/acts are described herein as occurring or being performed at a specified time. One of ordinary skill in the art would understand that such events/acts may occur or be performed at approximately the specified time.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of the technology, it is to be appreciated that various alterations, modifications, and improvements will readily occur to those skilled in the art.

Such alterations, modifications, and improvements are intended to be part of this disclosure, and are intended to be within the spirit and scope of the disclosure. Further, though advantages of the present technology are indicated, it should be appreciated that not every embodiment of the technology will include every described advantage. Some embodiments may not implement any features described as advantageous herein and in some instances. Accordingly, the foregoing description and drawings are by way of example only.

What is claimed is:

1. An electronic door lock system comprising:
an electronic lock configured to be coupled to a door, the electronic lock comprising at least one magnetometer;
a strike plate configured to be coupled to a frame of the door, the strike plate having a plurality of magnets disposed therein; and
at least one controller configured to determine whether the door is open or closed based on one or more measurements of magnetic field strength measured by the at least one magnetometer, wherein the plurality of magnets generate a magnetic field that contributes to the magnetic field strength measured by the at least one magnetometer.

2. The electronic door lock system of claim 1, wherein the at least one magnetometer comprises a pair of magnetometers disposed on opposing sides of the electronic lock.

3. The electronic door lock system of claim, wherein the at one magnetometer is coupled to an outer bezel of the electronic lock.

4. The electronic door lock system of claim 1, wherein the plurality of magnets comprise two magnets.

5. The electronic door lock system of claim 4, wherein the plurality of magnets comprise four magnets.

6. The electronic door lock system of claim 5, wherein the plurality of magnets are symmetrically disposed in the strike plate.

7. The electronic door lock system of claim 6, wherein respective ones of the plurality of magnets are disposed in respective corners of the strike plate.

8. The electronic door lock system of claim 1, wherein the plurality of magnets are disposed internally within the strike plate, such that the plurality of magnets are not visible when the strike plate is assembled.

9. The electronic door lock system of claim 8, wherein the plurality of magnets are disposed on a rear face of the strike plate and covered by a rear cover of the strike plate.

10. The electronic door lock system of claim 1, wherein the at least one controller is configured to control the at least one magnetometer to obtain the one or more measurements and/or increase the frequency of obtaining the one or more measurements based on a determination that the door has moved and/or a determination that a lock status of the lock has changed.

11. The electronic door lock system of claim 1, wherein the at least one controller is configured to determine whether the door is open or closed based on the one or more measurements of the at least one magnetometer at least in part by determining whether a difference between the one or more measurements and a calibration magnetic field strength exceeds a magnetic field strength differential threshold.

12. The electronic door lock system of claim 11, wherein the at least one controller is configured to determine that the door is open when the difference between the one or more measurements and the calibration magnetic field strength exceed the magnetic field strength differential threshold.

13. The electronic door lock system of claim 1, wherein the at least one controller is further configured to, based on the one or more measurements of the at least one magnetometer, determine that a position of the door has changed.

14. A method of monitoring a position of a door coupled to an electronic door lock system, the method comprising:
obtaining one or more measurements of magnetic field strength from at least one magnetometer of an electronic lock of the electronic door lock system coupled to the door, the electronic door lock system further comprising a strike plate coupled to a frame of the door and having a plurality of magnets disposed therein, wherein the plurality of magnets generate a magnetic field that contributes to the magnetic field strength measured by the at least one magnetometer; and
determining whether the door is open or closed based on the one or more measurements of magnetic field strength of the at least one magnetometer.

15. The method of claim 14, wherein the at least one magnetometer comprises a pair of magnetometers disposed on opposing sides of the electronic lock.

16. The method of claim 14, wherein the at one magnetometer is coupled to an outer bezel of the electronic lock.

17. The method of claim 14, wherein the plurality of magnets comprise two magnets.

18. The method of claim 17, wherein the plurality of magnets comprise four magnets.

19. The method of claim 18, wherein the plurality of magnets are symmetrically disposed in the strike plate.

20-26. (canceled)

27. At least one non-transitory computer-readable storage medium having instructions encoded thereon that, when executed by at least one processor, cause the at least one processor to perform a method of monitoring a position of a door coupled to an electronic door lock system, the method comprising:
obtaining one or more measurements of magnetic field strength from at least one magnetometer of an electronic lock of the electronic door lock system coupled to the door, the electronic door lock system further comprising a strike plate coupled to a frame of the door and having a plurality of magnets disposed therein, wherein the plurality of magnets generate a magnetic field that contributes to the magnetic field strength measured by the at least one magnetometer; and
determining whether the door is open or closed based on the one or more measurements of magnetic field strength of the at least one magnetometer.

28-132. (canceled)
